(19) United States
(12) Patent Application Publication
(10) Pub. No.: US 2026/0164514 A1
(43) Pub. Date: Jun. 11, 2026

(54) COOKING APPARATUS

(71) Applicant: SAMSUNG ELECTRONICS CO., LTD., Suwon-si (KR)

(72) Inventors: Seungwoo HAN, Suwon-si (KR); Sunwoo HAN, Suwon-si (KR); Jiwon JEONG, Suwon-si (KR)

(73) Assignee: SAMSUNG ELECTRONICS CO., LTD., Suwon-si (KR)

(21) Appl. No.: 19/406,372

(22) Filed: Dec. 2, 2025

Related U.S. Application Data
(63) Continuation of application No. PCT/KR2025/017530, filed on Oct. 30, 2025.

(30) Foreign Application Priority Data
Dec. 6, 2024 (KR) 10-2024-0181031

(51) Int. Cl. H05B 6/06; H05B 6/36

(52) U.S. Cl. CPC H05B 6/065; H05B 6/36; H05B 2206/02

(57) ABSTRACT

A cooking apparatus may include: a case; a cooking plate; an induction heating coil; a first circuit board, configured to remove noise and configured to reduce noise included in a current supplied from an external power source; a second circuit board configured to drive the induction heating coil; and a bracket coupleable to the case between the first circuit board and the second circuit board, configured to prevent electromagnetic interference (EMI) and configured to reduce EMI; wherein the bracket includes: a base configured to be arranged on a bottom of the case, and a partition extending upward from the base, and wherein the case includes: a first coupling portion configured to fix a corner of the base while the bracket is coupled to the case, and a second coupling portion configured to support the partition while the bracket is coupled to the case.

### Cross-Reference To Related Applications

This application is a continuation application of international application No. PCT/KR2025/017530, filed on October 30, 2025, which claims priority under 35 U. S. C. §119 to Korean Patent Application No. 10-2024-0181031, filed on December 6, 2024, the disclosures of which are incorporated herein by reference in their entireties.

### Technical Field

The disclosure relates to a cooking apparatus with an improved structure.

### Background Art

An induction heating device is an example of a cooking apparatus that heats and cooks food using the principle of induction heating. The induction heating device includes a cooking plate on which a cooking vessel is placed, and a working coil that generates a magnetic field when an electric current is applied.

When a magnetic field is generated by applying a current to the working coil, a secondary current is induced in the cooking vessel, and Joule heat is generated by the resistance component of the cooking vessel itself. Thus, the cooking vessel is heated by the high-frequency current, and the food contained in the cooking vessel is cooked.

Since such an induction heating device uses the cooking vessel itself as a heat source, it has advantages, such as a higher heat transfer rate, no harmful gases, and no risk of fire, compared to a gas range or a kerosene stove that burns fossil fuels and heats the cooking vessel through the heat of combustion.

### Summary

An embodiment of the present disclosure provides a cooking apparatus with improved assemblability and productivity.

An embodiment of the present disclosure provides a cooking apparatus including a bracket coupleable to a case without a separate tool or a separate fastening member, such as a screw, a rivet, or the like.

An embodiment of the present disclosure provides a cooking apparatus including a bracket that may prevent and/or reduce electromagnetic interference (EMI).

Technical tasks to be achieved in this document are not limited to the technical tasks mentioned above, and other technical tasks not mentioned will be clearly understood by those skilled in the art from the description below.

According to an embodiment of the disclosure, a cooking apparatus may include: a case; a cooking plate mountable on the case; an induction heating coil inside the case; a first circuit board inside the case, configured to remove noise and configured to reduce noise included in a current supplied from an external power source; a second circuit board inside the case and configured to drive the induction heating coil; and a bracket coupleable to the case between the first circuit board and the second circuit board, configured to prevent electromagnetic interference (EMI) and configured to reduce EMI. The bracket may include: a base configured to be arranged on a bottom of the case, and a partition extending upward from the base. The case may include: a first coupling portion, formed on the bottom of the case, configured to fix a corner of the base while the bracket is coupled to the case. The case may include: a second coupling portion, formed on the bottom of the case, configured to support the partition while the bracket is coupled to the case.

A cooking apparatus according to an embodiment of the present disclosure may include: a case; an induction heating coil disposed inside the case; a first circuit board disposed inside the case and including a filter coil; a second circuit board disposed inside the case to be spaced apart from the first circuit board along a first direction and including a wire configured to be connected to the induction heating coil; a partition configured to extend along a second direction intersecting the first direction between the first circuit board and the second circuit board; and a base protruding from the partition in the first direction and including an insertion hole. The case may include a coupling portion formed on a bottom of the case and insertable into the insertion hole. The coupling portion may include a first rib portion disposed within the insertion hole and configured to restrict movement of the base along the second direction. The coupling portion may include a second rib portion extending from the first rib portion and disposed above the base to restrict the movement of the base along a vertical direction.

### DESCRIPTION OF DRAWINGS

FIG. 1 is a perspective view of a cooking apparatus according to an embodiment of the present disclosure.

FIG. 2 is an exploded view of a cooking apparatus according to an embodiment of the present disclosure.

FIG. 3 is a view illustrating the principle by which a cooking apparatus heats a cooking vessel, according to an embodiment of the present disclosure.

FIG. 4 is a control block view of the cooking apparatus according to an embodiment of the present disclosure.

FIG. 5 is a circuit view of the cooking apparatus according to an embodiment of the present disclosure.

FIG. 6 is a perspective view of some configurations of the cooking apparatus according to an embodiment of the present disclosure.

FIG. 7 is a plan view of some configurations of the cooking apparatus according to an embodiment of the present disclosure.

FIG. 8 is an exploded view illustrating a case and a bracket of a cooking apparatus according to an embodiment of the present disclosure.

FIG. 9 is an exploded view illustrating the case and the bracket of the cooking apparatus according to an embodiment of the present disclosure, as viewed from a direction different from that of FIG. 8.

FIG. 10 is a perspective view of the bracket according to an embodiment of the present disclosure.

FIG. 11 is an enlarged view of portion A shown in FIG. 10.

FIG. 12 is a cutaway perspective view of the case according to an embodiment of the present disclosure.

FIG. 13 is an enlarged view of portion B shown in FIG. 12.

FIG. 14 is an enlarged view of portion C shown in FIG. 12.

FIG. 15 is an enlarged view of portion D shown in FIG. 12.

FIG. 16 is an enlarged view of portion E shown in FIG. 12.

FIG. 17 is a view illustrating a process of assembling the case and the bracket according to an embodiment of the present disclosure.

FIG. 18 is a cross-sectional view taken along line I-I' shown in FIG. 17.

FIG. 19 is a view illustrating a process of assembling the case and the bracket according to an embodiment of the present disclosure.

FIG. 20 is a cross-sectional view taken along line II-II' shown in FIG. 19.

FIG. 21 is a view illustrating a process of assembling the case and the bracket according to an embodiment of the present disclosure.

FIG. 22 is a cross-sectional view taken along line III-III' shown in FIG. 21.

FIG. 23 is an enlarged view of portion F shown in FIG. 21.

FIG. 24 is an enlarged view of portion G shown in FIG. 21.

FIG. 25 is a cross-sectional view of a portion of the case according to an embodiment of the present disclosure.

FIG. 26 is a cross-sectional view illustrating a state in which the bracket is coupled to the case shown in FIG. 25, according to an embodiment of the present disclosure.

FIG. 27 is a cross-sectional view of a part of the case according to an embodiment of the present disclosure.

FIG. 28 is a cross-sectional view illustrating a state in which the bracket is coupled to the case shown in FIG. 27, according to an embodiment of the present disclosure.

FIG. 29 is a cross-sectional view of a part of the case according to an embodiment of the present disclosure.

FIG. 30 is a cross-sectional view illustrating a state in which the bracket is coupled to the case shown in FIG. 29, according to an embodiment of the present disclosure.

### Modes of the Invention

Embodiments described in the disclosure and configurations shown in the drawings are merely examples of the embodiments of the disclosure and may be modified in various different ways at the time of filing of the present application to replace the embodiments and drawings of the disclosure.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

The terms “part”, “portion”, “block”, “unit”, “module”, “member”, and the like may include a unit that handles at least one function or operation. In some embodiments, a plurality of “parts”, “portions”, “blocks”, “units”, “modules”, and “members” may be implemented as a single component, or a single “part”, “portion”, “block”, “unit”, “module”, and “member” may comprise a plurality of components. The terms may be implemented in hardware and/or software. The terms may refer to at least one piece of hardware, at least one piece of software stored in memory, or at least one process processed by a processor.

Terms such as “1st”, “2nd”, “primary”, or “secondary” may be used simply to distinguish a component from other components, without limiting the component in other aspects (e.g., importance or order).

When a component (e.g., a first component) is referred to as “coupled” or “connected” to another component (e.g., a second component), with or without the terms “functionally” or “communicatively,” it may refer to that the component may be connected to another component directly (e.g., wired), wirelessly, or through a third component.

It will be understood that when the terms “includes”, “having”, “comprises”, “including”, “having”, and/or “comprising”, when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it can be directly on the other component or intervening components may also be present.

Meanwhile, the terms such as “front”, “rear”, “upper”, “lower”, “left”, “right”, and the like used in the following description are defined based on the drawings, and the shapes and positions of the respective elements are not limited by these terms. For example, “front” and “rear” may be defined based on an X-axis shown in the drawings. For example, “left” and “right” may be defined based on a Y-axis shown in the drawings. For example, “upper” and “lower” may be defined based on a Z-axis shown in the drawings.

Hereinafter, various embodiments of the present disclosure will be described in detail with reference to the accompanying drawings.

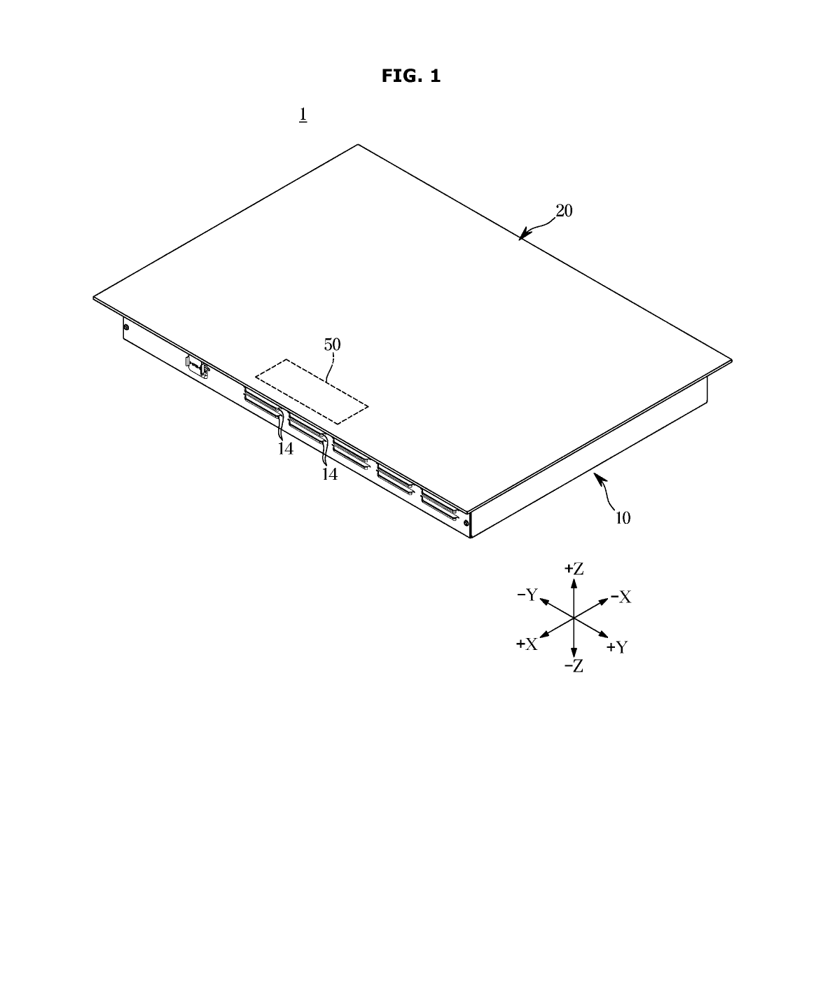

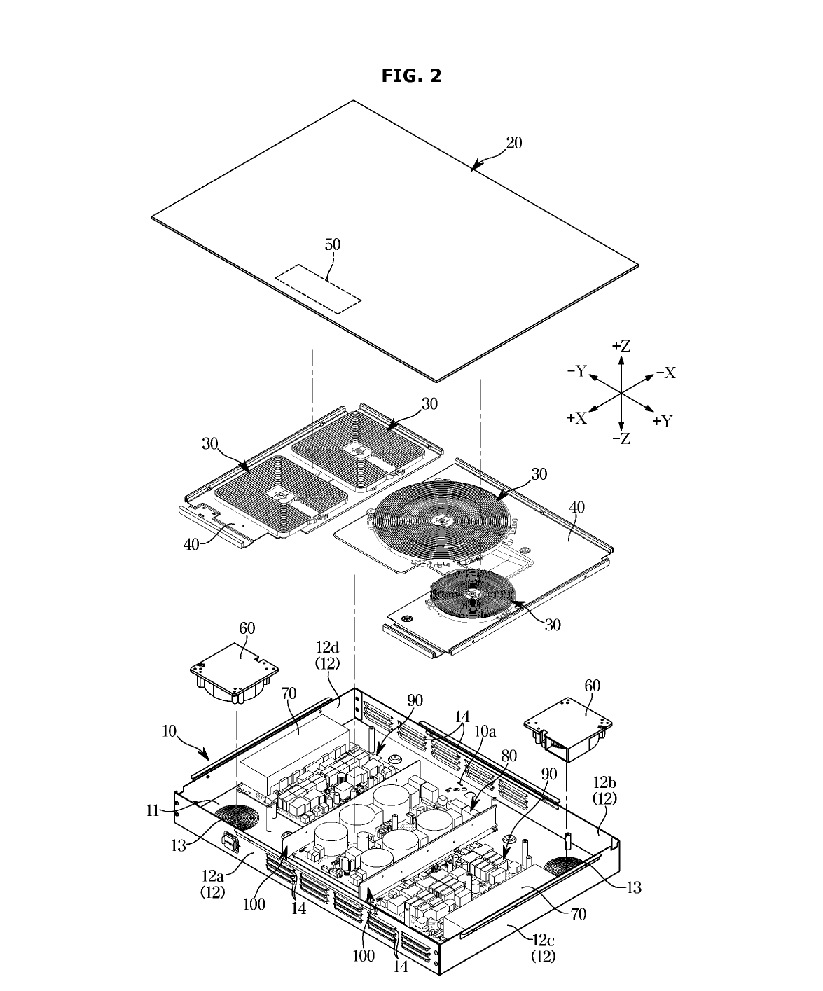

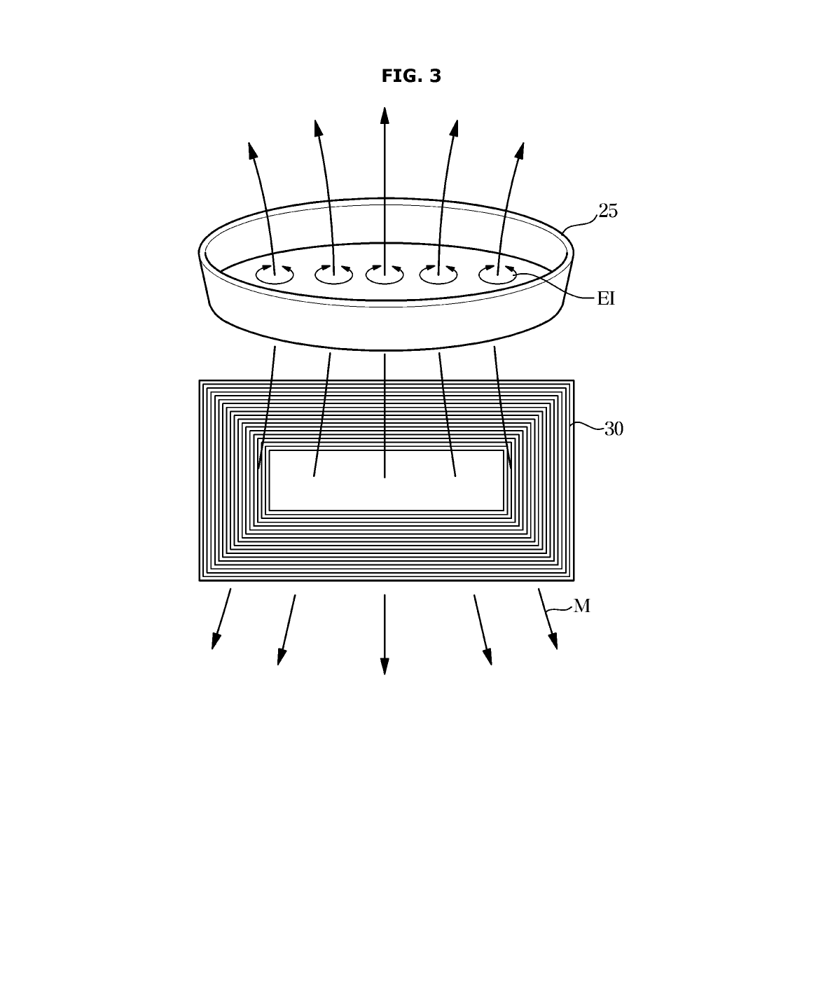

FIG. 1 is a perspective view of a cooking apparatus according to an embodiment of the present disclosure. FIG. 2 is an exploded view of the cooking apparatus according to an embodiment of the present disclosure. FIG. 3 is a view illustrating the principle by which a cooking apparatus heats a cooking vessel, according to an embodiment of the present disclosure.

Referring to FIGS. 1 and 2, a cooking apparatus 1 may include a case 10. The case 10 may accommodate various configurations constituting the cooking apparatus 1. The case 10 may form at least a portion of an exterior of the cooking apparatus 1. The case 10 may be referred to as a housing 10, a main body 10, and the like.

For example, the case 10 may include a shape with an open top. The case 10 may include a substantially box shape with an open top. The case 10 may include a bottom 11 and a side wall 12 extending upwardly from the bottom 11. The case 10 may include a front wall 12a, a rear wall 12b, a right wall 12c, and a left wall 12d. The case 10 may form a receiving space 10a. The receiving space 10a may be defined by the bottom 11 and the side wall 12. The receiving space 10a may be provided with an induction heating coil 30, a fan 60, a heat sink 70, circuit boards 80 and 90, a bracket 100, and the like, which will be described later.

The case 10 may include an inlet 13. Air from outside may flow into the case 10 through the inlet 13. The air introduced into the case 10 through the inlet 13 may cool various components received in the case 10. For example, the inlet 13 may be formed on the bottom 11 of the case 10.

The case 10 may include an outlet 14. The air in the case 10 may flow to an outside of the case 10 through the outlet 14. The air that has cooled the various components received in the case 10 may be discharged to the outside of the case 10 through the outlet 14. For example, the outlet 14 may be formed on the side wall 12 of the case 10.

The cooking apparatus 1 may include a cooking plate 20. A cooking vessel 25 (see FIG. 3) may be placed on the cooking plate 20. The cooking plate 20 may support the cooking vessel 25. The cooking plate 20 may be coupled to the case 10. The cooking plate 20 may cover the open top of the case 10. The cooking plate 20 may be mountable on the case 10. The cooking plate 20 may form an upper surface of the cooking apparatus 1. For example, the cooking plate 20 may include a substantially flat plate shape. For example, the cooking plate 20 may include tempered glass, such as ceramic glass, to prevent/reduce easy breakage. For example, a guide mark may be formed on the cooking plate 20 to guide a user to a position at which the cooking vessel 25 may be heated.

The cooking apparatus 1 may include a user interface 50. The user interface 50 may receive control commands from a user and display operation information of the cooking apparatus 1 to the user. In an example, the user interface 50 may be realized on the cooking plate 20. However, the present disclosure is not limited thereto, and the position of the user interface 50 is not limited thereto. In an example, the user interface 50 may also be provided on the case 10.

The cooking apparatus 1 may include the induction heating coil 30. The induction heating coil 30 may be disposed inside the case 10. The induction heating coil 30 may be disposed below the cooking plate 20. The induction heating coil 30 may be configured to heat the cooking vessel 25 placed on the cooking plate 20. The induction heating coil 30 may generate a magnetic field to heat the cooking vessel 25. The induction heating coil 30 may be referred to as a working coil 30, a heating coil 30, a heating unit 30, a heating module 30, a heating device 30, and the like.

Although FIG. 2 shows four induction heating coils 30, the number of induction heating coils 30 is not limited thereto. The induction heating coil 30 may be provided as a single unit. The induction heating coils 30 may also be provided as a plurality of two or more.

For example, the principle of heating the cooking vessel 25 will be described with reference to FIG. 3. When a drive current is supplied to the induction heating coil 30, a magnetic field M may be induced around the induction heating coil 30. When a current whose magnitude and direction change over time, i.e., an alternating current, is supplied to the induction heating coil 30, a magnetic field M whose magnitude and direction change vary over time may be induced around the induction heating coil 30. The magnetic field M around the induction heating coil 30 may pass through the cooking plate 20 and reach the cooking vessel 25 placed on the cooking plate 20. Due to the magnetic field M that varies in magnitude and direction with time, an eddy current EI that rotate around the magnetic field M may be generated in the cooking vessel 25. The phenomenon in which an eddy current is generated by a time-varying magnetic field M, may be referred to as electromagnetic induction. Due to the EI, electrical resistance heat may be generated in the cooking vessel 25. The electrical resistance heat, also called Joule heat, refers to the heat generated in a resistor when an electric current flows therethrough. The cooking vessel 25 is heated by such electrical resistance heat, and food contained in the cooking vessel 25 may be heated.

The cooking apparatus 1 may include a support plate 40. The support plate 40 may be configured to support the induction heating coil 30. The support plate 40 may be disposed between the bottom 11 of the case 10 and the cooking assembly 20. The support plate 40 may be detachably coupled to the side wall 12 of the case 10. For example, the support plate 40 may include a substantially flat plate shape.

The support plate 40 may include a material capable of magnetic shielding. The support plate 40 may block the magnetic field formed in the induction heating coil 30 from leaking to a first circuit board 80 and/or a second circuit board 90, which will be described later. Accordingly, the first circuit board 80 and/or the second circuit board 90 may be configured to be unaffected by the induced magnetic field by the support plate 40.

The cooking apparatus 1 may include the fan 60. The fan 60 may be disposed inside the case 10. The fan 60 may be configured to lower the temperature inside the case 10 by forcibly circulating air. The fan 60 may be configured to lower the temperature of at least one circuit board 80 and/or 90. The fan 60 may operate to draw in air from outside the cooking apparatus 1 through the inlet 13. In an example, the air intake side of the fan 60 may be disposed to face the inlet 13. The fan 60 may operate to discharge air inside the cooking apparatus 1 through the outlet 14. In an example, the air discharge side of the fan 60 may be disposed to face the heat sink 70, which will be described later. Outside air introduced into the case 10 by the fan 60 may cool the at least one circuit board 80 and/or 90 accommodated in the case 10 and then be discharged to the outside of the case 10.

Although FIG. 2 shows two fans 60, the number of fans 60 is not limited thereto. One fan 60 may be provided. Three or more fans 60 may be provided.

For example, the fan 60 may be implemented as an axial fan or a mixed-flow fan may be applied to the fan 60. However, as long as the fan 60 may draw in air from outside the case 10 and discharge air inside the case 10 back to the outside of the case 10, the type of the fan 60 is not limited to the examples described above.

The cooking apparatus 1 may include the heat sink 70. The heat sink 70 may be disposed inside the case 10. In an example, the heat sink 70 may be disposed adjacent to the side wall 12. The heat sink 70 may be configured to absorb and dissipate heat. The heat sink 70 may be configured to receive heat from at least one circuit board 80 and/or 90 and dissipate the received heat. The heat sink 70, together with the fan 60, may form a cooling airflow inside the case 10. Accordingly, overheating inside the case 10 may be prevented and/or suppressed. The heat sink 70 may include a material with high thermal conductivity. For example, the heat sink 70 may include at least one of aluminum, copper, or the like.

Although FIG. 2 shows two heat sinks 70, the number of heat sinks 70 is not limited thereto. One heat sink 70 may be provided. Three or more heat sinks 70 may be provided.

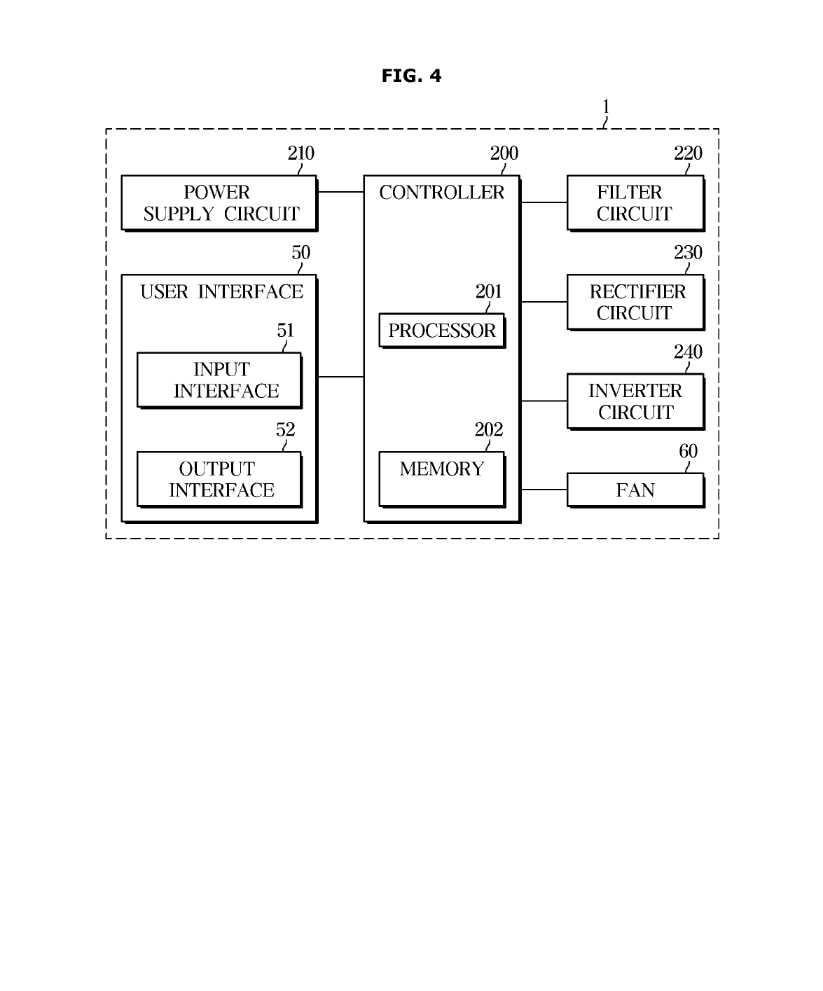

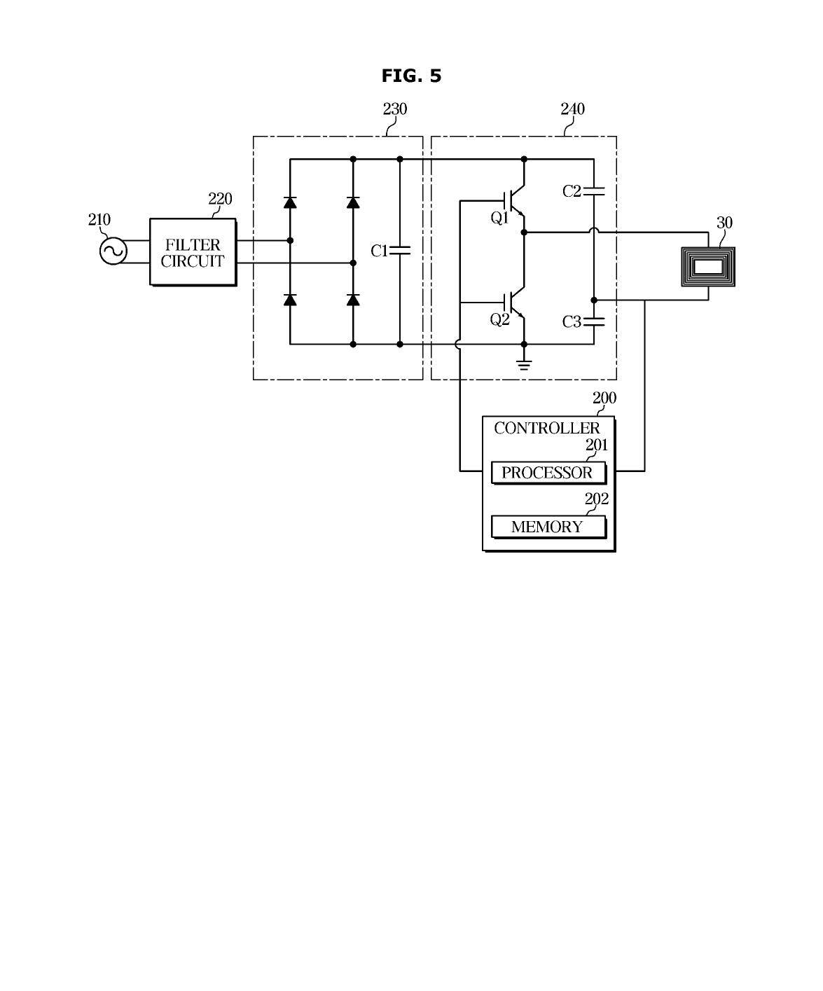

The cooking apparatus 1 may include the first circuit board 80. The first circuit board 80 may be disposed inside the case 10. In an example, the first circuit board 80 may be placed on the bottom 11 of the case 10. The first circuit board 80 may be configured to remove and/or reduce noise included in the current supplied from an external power source. For example, the first circuit board 80 may include a filter circuit 220 (see FIGS. 4 and 5).

Although FIG. 2 shows one first circuit board 80, the present disclosure is not limited thereto, and there is no limitation on the number of first circuit boards 80.

The cooking apparatus 1 may include the second circuit board 90. The second circuit board 90 may be disposed inside the case 10. In an example, the second circuit board 90 may be arranged to be placed on the bottom 11 of the case 10. The second circuit board 90 may be configured to drive the induction heating coil. The second circuit board 90 may be configured to supply a drive current to the induction heating coil. The second circuit board 90 may include a circuit for operating the induction heating coil by receiving current from the first circuit board 80. For example, the second circuit board 90 may include a rectifier circuit 230 (see FIGS. 4 and 5) and an inverter circuit 240 (see FIGS. 4 and 5).

Although FIG. 2 shows two second circuit boards 90, the present disclosure is not limited thereto, and there is no limitation on the number of second circuit boards 90.

The cooking apparatus 1 may include the bracket 100. The bracket 100 may be disposed inside the case 10. The bracket 100 may be configured to prevent and/or reduce electromagnetic interference between the circuit boards 80 and 90. The bracket 100 may be referred to as a frame 100, a panel 100, or the like.

Although FIG. 2 shows two brackets 100, the present disclosure is not limited thereto. The number of brackets 100 may vary depending on the number and/or arrangement of the circuit boards 80 and 90.

A detailed description of the bracket 100 will be described later.

FIG. 4 is a control block view of the cooking apparatus according to an embodiment of the present disclosure.

Referring to FIG. 4, the cooking apparatus 1 according to an embodiment of the present disclosure may include a power supply circuit 210, a filter circuit 220, a rectifier circuit 230, an inverter circuit 240, a user interface 50, the fan 60, and a controller 200.

The power supply circuit 210 may be configured to receive alternating current (AC) power from an external power source. For example, the power supply circuit 210 may receive external AC power and convert the received AC power into three-phase AC power. The power supply circuit 210 may be configured to supply the applied AC power to the rectifier circuit 230 and the inverter circuit 240.

The filter circuit 220 may block high-frequency noise included in the AC power supplied from the external power source through the power supply circuit 210, and may allow an AC voltage and an AC current of a predetermined frequency to pass through. For example, the filter circuit 220 may include at least one of a common mode filter, a normal mode filter, an X-CAP (across the line capacitor), a Y-CAP (line bypass capacitor), and a varistor. The filter circuit 220 may be implemented on the first circuit board 80.

The rectifier circuit 230 may convert AC power into direct current (DC) power. The rectifier circuit 230 may convert an AC voltage, whose magnitude and polarity (positive or negative voltage) vary over time, into a DC voltage with a constant magnitude and polarity. The rectifier circuit 230 may convert an AC current, whose magnitude and direction (positive or negative current) vary over time, into a DC current with a constant magnitude. The rectifier circuit 230 may be implemented on the second circuit board 90.

The inverter circuit 240 may be supplied with DC power from the rectifier circuit 230. The inverter circuit 240 may supply a drive current to the induction heating coil 30 or cut off the drive current supplied to the induction heating coil 30. As the inverter circuit 240 supplies a drive current to the induction heating coil 30, the cooking vessel placed on the cooking plate 20 may be heated. The inverter circuit 240 may be implemented on the second circuit board 90.

The user interface 50 may allow a user and the cooking apparatus 1 to interact. The controller 200 may process user input received through the user interface 50 and output information related to the cooking apparatus 1 through the user interface 50.

The user interface 50 may include at least one output interface 52 and at least one input interface 51.

The at least one output interface 52 may deliver various information related to operation of the cooking apparatus 1 to the user by generating sensory information. For example, the at least one output interface 52 may deliver information related to the settings of the cooking apparatus 1 and the operating time of the cooking apparatus 1 to the user. Information regarding the operation of the cooking apparatus 1 may be output via a display, an indicator, and/or a sound. The at least one output interface 52 may include, for example, a liquid crystal display (LCD) panel, an indicator, a light emitting diode (LED) panel, a speaker, or the like. The at least one output interface 52 may output sensory information (e.g., visual information, auditory information, etc.) related to the control of the cooking apparatus 1.

The at least one input interface 51 may deliver sensory information received from the user into an electrical signal. The at least one input interface 51 may include an input device (e.g., a button, a knob, etc.) for turning on the power of the cooking apparatus 1. The at least one input interface 51 may include an input device for adjusting the drive current supplied to the induction heating coil 30. Each input device may include a visual indicator (e.g., text, icon, etc.) that may represent its function. The at least one input interface 51 may include, for example, a tact switch, a push switch, a slide switch, a toggle switch, a micro switch, a touch switch, a touch pad, a touch screen, a jog dial, and/or a microphone. In the present disclosure, 'button' may be interchangeable with a user interface (UI) element, a tact switch, a push switch, a slide switch, a toggle switch, a micro switch, a touch switch, a touch pad, a touch screen, a jog dial, and/or a microphone.

The fan 60 may operate to appropriately maintain the temperature inside the case 10. The controller 200 may be configured to control the on/off state of the fan 60, the rotation speed of the fan 60, the rotational direction of the fan 60, and the like.

The controller 200 may control various configurations of the cooking apparatus 1.

The controller 200 may include at least one processor 201 that controls the operation of the cooking apparatus 1 and at least one memory 202 that stores programs and data for controlling the operation of the cooking apparatus 1.

The at least one memory 202 may store data necessary for various embodiments. The at least one memory 202 may be implemented in the form of a memory embedded in the cooking apparatus 1 or a memory detachable from the cooking apparatus 1, depending on the purpose of data storage. For example, data for driving the cooking apparatus 1 may be stored in a memory embedded in the cooking apparatus 1, and data for extended functions of the cooking apparatus 1 may be stored in a memory detachable from the cooking apparatus 1. For example, the at least one memory 202 may be a volatile memory (e.g., dynamic random access memory (DRAM), static RAM (SRAM), or synchronous dynamic RAM (SDRAM), etc.), a non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)), a memory card (e.g., compact flash (CF), secure digital (SD), micro secure digital (Micro-SD), mini secure digital (Mini-SD), extreme digital (xD), multi-media card (MMC), etc.), an external memory connectable to a USB port (e.g., a USB memory), or the like.

The at least one processor 201 may generally control the operation of the cooking apparatus 1. Specifically, the at least one processor 201 may be electrically connected to each configuration of the cooking apparatus 1 to generally control the operation of the cooking apparatus 1. The at least one processor 201 may be electrically connected to the memory 202 to control the overall operation of the cooking apparatus 1. The processor 201 may include one or more processors. For example, the at least one processor 201 may include one or more of a central processing unit (CPU), a graphics processing unit (GPU), an accelerated processing unit (APU), a many integrated core (MIC), a digital signal processor (DSP), a neural processing unit (NPU), a hardware accelerator, a machine learning accelerator, or the like.

FIG. 5 is a circuit view of the cooking apparatus according to an embodiment of the present disclosure.

Referring to FIG. 5, the cooking apparatus 1 according to an embodiment of the present disclosure may include the power supply circuit 210, the filter circuit 220, the rectifier circuit 230, the inverter circuit 240, the controller 200, and the induction heating coil 30.

The power supply circuit 210 may be configured to receive AC power from an external power source. The filter circuit 220 may be configured to block high-frequency noise included in the AC power. The rectifier circuit 230 may convert the AC power, from which the high-frequency noise has been blocked, into DC power. The power rectified by the rectifier circuit 230 may be applied to the inverter circuit 240. The inverter circuit 240 may be electrically connected to the induction heating coil 30 to drive the induction heating coil 30.

For example, the rectifier circuit 230 may include a bridge diode. For example, the rectifier circuit 230 may include four diodes. The diodes may form a pair of diodes connected in series, and the two pairs of diodes may be connected in parallel with each other. The bridge diode may convert an AC voltage, whose polarity varies over time, into a positive voltage with a constant polarity, and may convert an AC current, whose direction varies over time, into a positive current with a constant direction. For example, the rectifier circuit 230 may include a capacitor C1 connected in parallel with at least one diode.

For example, the inverter circuit 240 may include a pair of switch elements Q1 and Q2. For example, the inverter circuit 240 may include a pair of resonant capacitors C2 and C3. The pair of switch elements Q1 and Q2 may be connected in parallel with the pair of resonant capacitors C2 and C3. For example, one of the two ends of the induction heating coil 30 may be connected to a node in which the pair of switch elements Q1 and Q2 are connected in series. For example, the other of the two ends of the induction heating coil 30 may be connected to a node in which the pair of resonant capacitors C2 and C3 are connected in series.

The pair of switching elements Q1 and Q2 may include a first switching element Q1 and a second switching element Q2. The first switching element Q1 may be closed or opened according to the control of the controller 200. The second switching element Q2 may be closed or opened according to the control of the controller 200.

The pair of resonant capacitors C2 and C3 may include a first resonant capacitor C2 and a second resonant capacitor C3. The first resonant capacitor C2 and the second resonant capacitor C3 may be connected in series between a plus line and a minus line.

Depending on the switching operations (i.e., opening and closing) of the first switching element Q1 and the second switching element Q2, a current may be output from the first resonant capacitor C2 and/or the second resonant capacitor C3 to the induction heating coil 30, or a current may be input from the induction heating coil 30 to the first resonant capacitor C2 and/or the second resonant capacitor C3.

The inverter circuit 240 may control the current supplied to the induction heating coil 30. The magnitude and direction of the current flowing through the induction heating coil 30 may vary depending on the switching operations of the first switching element Q1 and the second switching element Q2 included in the inverter circuit 240.

For example, the controller 200 may determine a switching cycle of the first switching element Q1 and the second switching element Q2 based on a user command input via the user interface 50 (see FIG. 4), thereby determining the strength of the magnetic field output from the induction heating coil 30.

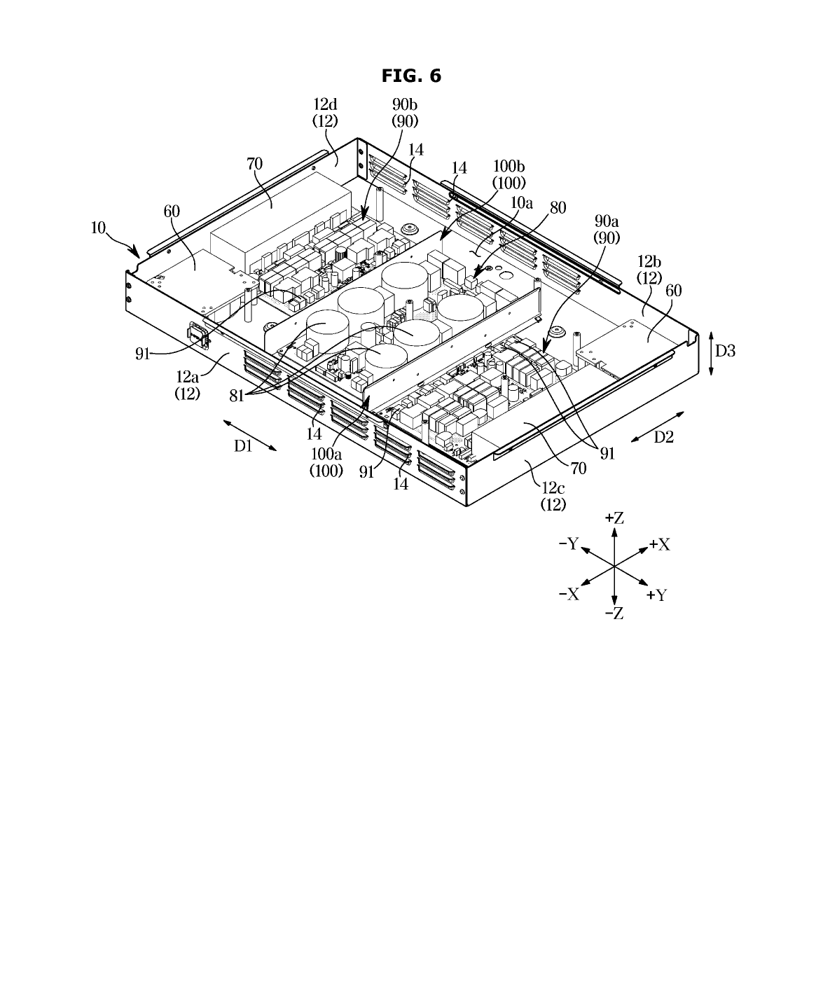

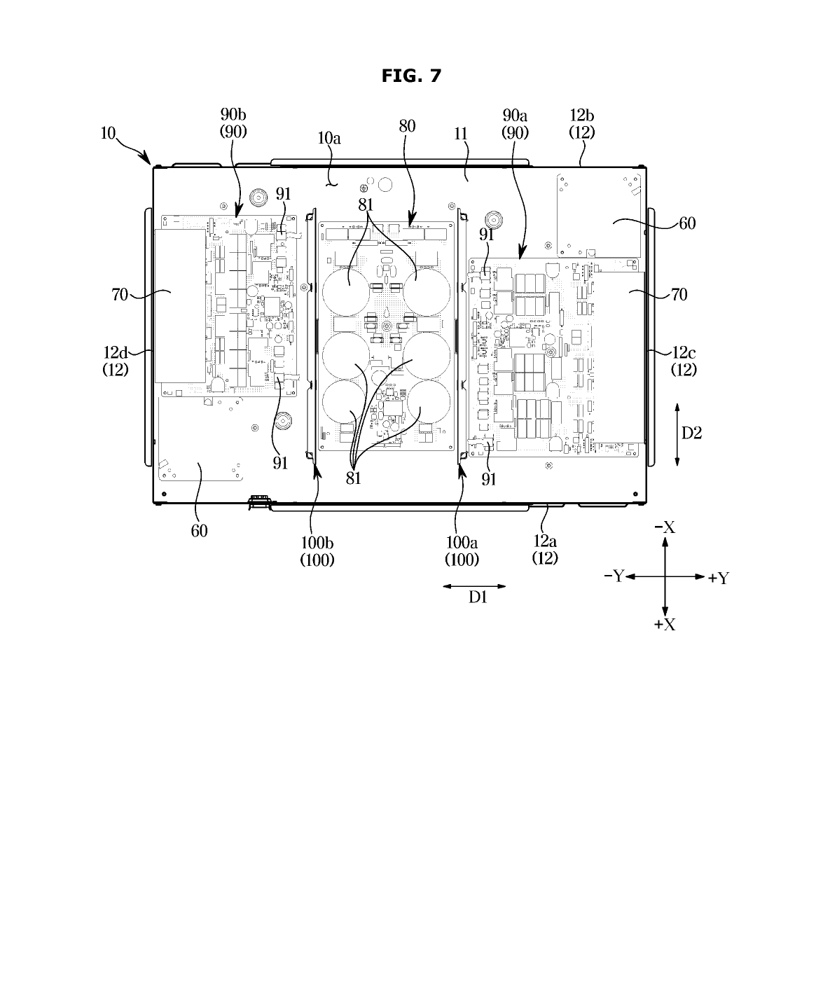

FIG. 6 is a perspective view of some configurations of the cooking apparatus according to an embodiment of the present disclosure. FIG. 7 is a plan view of some configurations of the cooking apparatus according to an embodiment of the present disclosure.

Referring to FIGS. 6 and 7, the first and second circuit boards 80 and 90 may be disposed inside the case 10. The first and second circuit boards 80 and 90 may be disposed spaced apart from each other along a first direction D1. The first and second circuit boards 80 and 90 may be arranged along the first direction D1. For example, the first direction D1 may include a substantially horizontal direction (Y direction).

For example, the first circuit board 80 may be disposed between two second circuit boards 90. One second circuit board 90a may be disposed on the right side of the first circuit board 80, and the other second circuit board 90b may be disposed on the left side of the first circuit board 80. The one second circuit board 90a and the other second circuit board 90b may perform substantially the same function, with only their arrangement being different. The description of the second circuit board 90 may be applied to both the second circuit board 90a and the second circuit board 90b.

The first circuit board 80 may include a filter coil 81. The filter coil 81 may be configured to limit the current of a specific frequency. The filter coil 81 may be configured to block the passage of high-frequency noise. The filter coil 81 may be provided as one configuration of the filter circuit 220.

The second circuit board 90 may include a wire 91. The wire 91 may be connected to the induction heating coil 30. The wire 91 may connect the inverter circuit 240 and the induction heating coil 30. The second circuit board 90 may supply a drive current to the induction heating coil 30 through the wire 91.

The bracket 100 may be disposed between the first and second circuit boards 80 and 90. The bracket 100 may be disposed between the filter coil 81 and the wire 91. The bracket 100 may be configured to partition a portion of the receiving space 10a of the case 10. The bracket 100 may be configured to prevent and/or reduce EMI. The bracket 100 may be configured to prevent and/or reduce electromagnetic interference between the filter coil 81 and the wire 91. In an example, the bracket 100 may include a metal material.

The bracket 100 may include a shape extending substantially along a second direction D2. The second direction D2 may be a direction that intersects the first direction D1. For example, the second direction D2 may include a substantially front-to-back direction (X direction).

For example, the cooking apparatus 1 may include two brackets 100. One bracket 100a may be disposed between the first circuit board 80 and one second circuit board 90a, and the other bracket 100b may be disposed between the first circuit board 80 and the other second circuit board 90b. The one bracket 100a and the other bracket 100b may perform substantially the same function, with only their arrangement being different. The description of the bracket 100 may be applied to both the one bracket 100a and the other bracket 100b. However, the present disclosure is not limited to the examples described above.

In general, a cooking apparatus may include an electronic component (hereinafter referred to as a 'first component') for removing noise included in the current supplied from an external source, and an electronic component (hereinafter referred to as a 'second component') for providing a drive current to the induction heating coil. To prevent/reduce electromagnetic interference between the first component and the second component, a sufficient space may be secured between the first component and the second component. However, to improve the performance of the cooking apparatus, the first component and the second component may be enlarged, and the space between the first component and the second component may become narrow. In such a case, it may not be easy for the cooking apparatus to satisfy EMI standards.

According to the present disclosure, the cooking apparatus 1 may include the bracket 100 disposed between the first and second circuit boards 80 and 90. The bracket 100 may prevent and/or reduce electromagnetic interference that may occur between the first and second circuit boards 80 and 90. Accordingly, even when the size of the first and second circuit boards 80 and 90 is increased in order to improve the performance of the cooking apparatus 1, the cooking apparatus 1 may sufficiently satisfy the EMI standards.

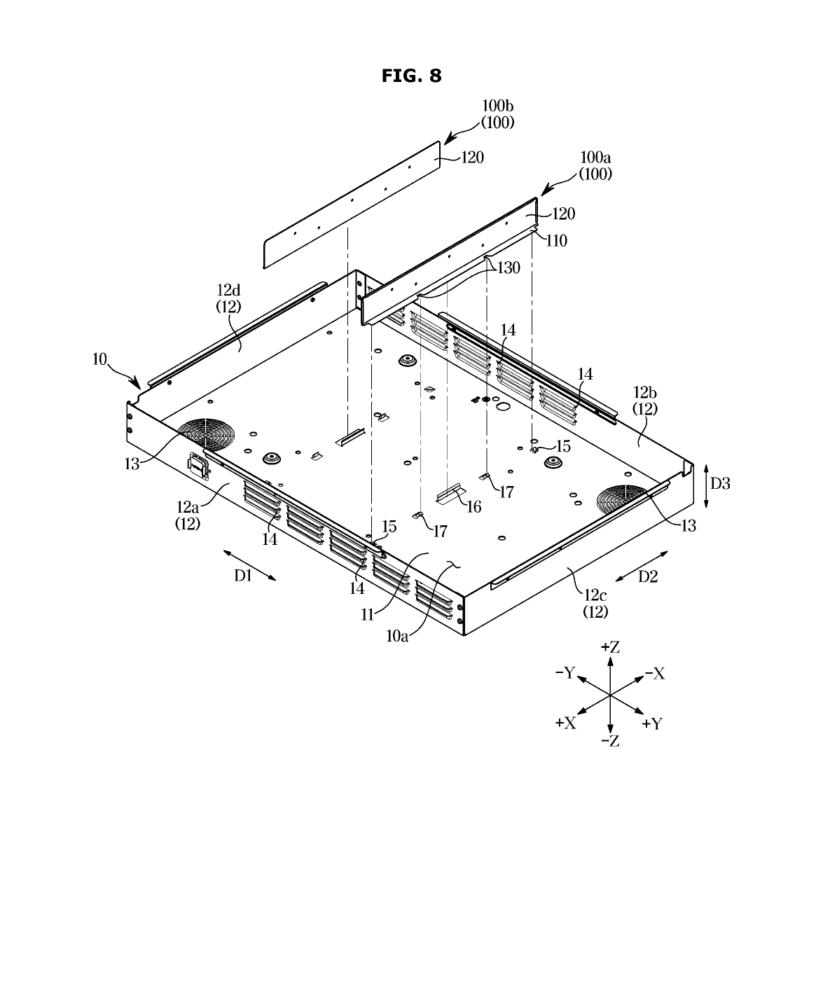

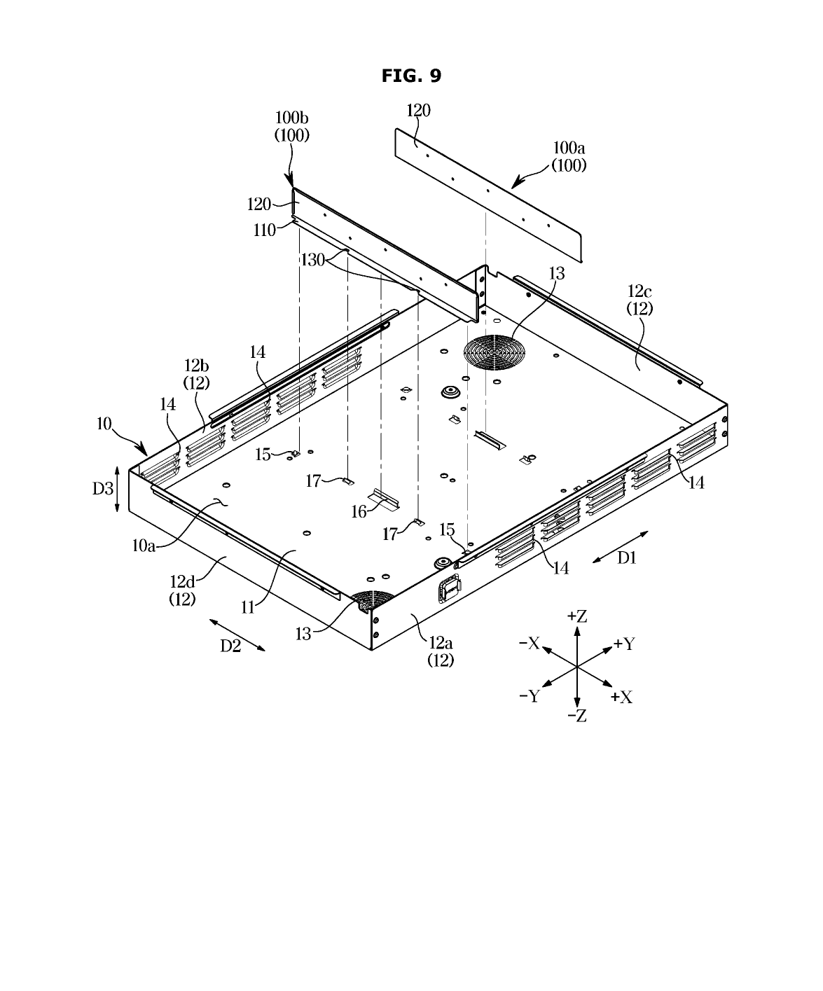

FIG. 8 is an exploded view illustrating a case and a bracket of the cooking apparatus according to an embodiment of the present disclosure. FIG. 9 is an exploded view illustrating the case and the bracket of the cooking apparatus according to an embodiment of the present disclosure, viewed from a direction different from that of FIG. 8.

Referring to FIGS. 8 and 9, the bracket 100 may be configured to be detachably coupleable to the case 10. The bracket 100 may be configured to be detachably mountable to the case 10. The bracket 100 may be assembled to the case 10, so it may be disposed between the first and second circuit boards 80 and 90 (see FIGS. 6 and 7).

Generally, when a bracket is coupled to a case, a separate tool or a separate fastening member (e.g., a screw, a rivet, etc.) may be required. However, according to an embodiment of the present disclosure, the bracket 100 may be coupled to the case 10 without a separate tool or a separate fastening member. This may reduce the time and/or labor required for coupling the case 10 and the bracket 100. The number of parts required for assembling the cooking apparatus 1 may be reduced. The assemblability and productivity of the cooking apparatus 1 may be improved.

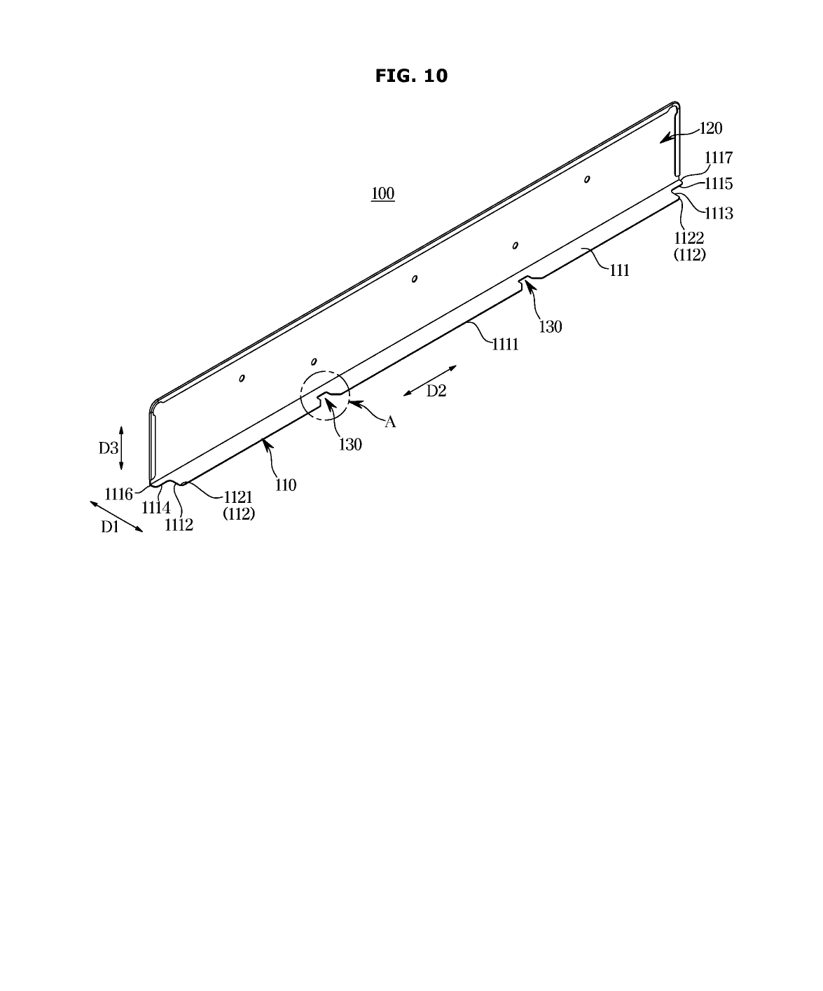

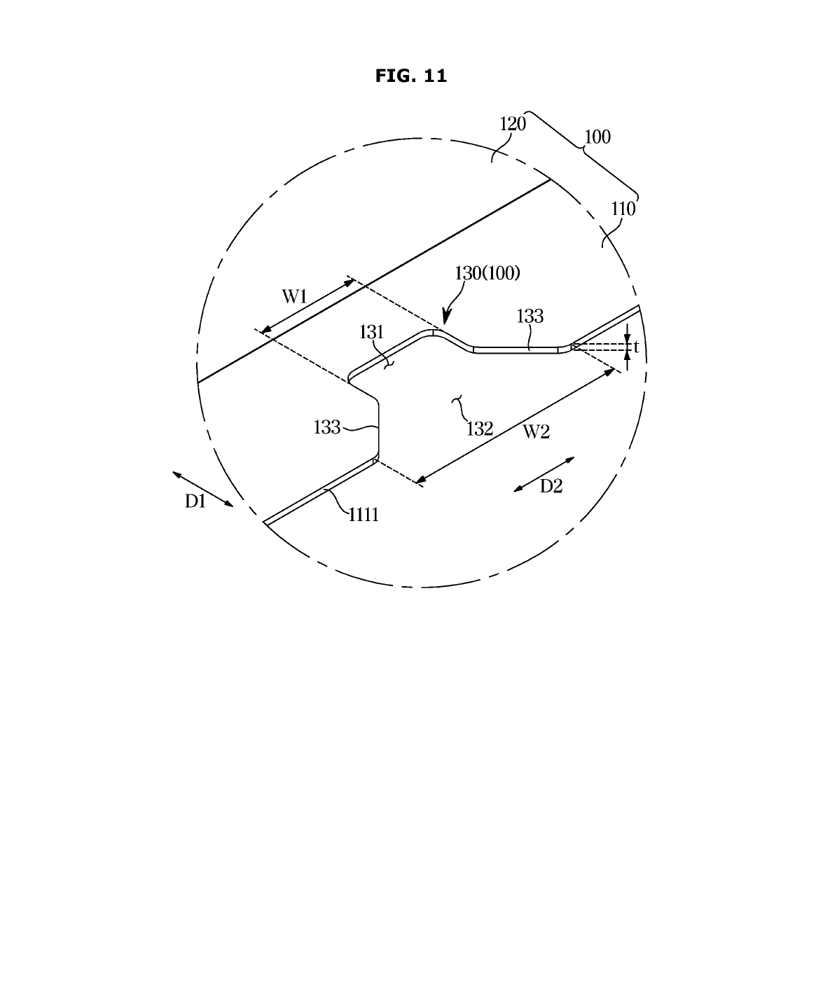

FIG. 10 is a perspective view of the bracket according to an embodiment of the present disclosure. FIG. 11 is an enlarged view of portion A shown in FIG. 10.

Referring to FIGS. 10 and 11, the bracket 100 according to an embodiment of the present disclosure may include a base 110, a partition 120, and an insertion hole 130.

The bracket 100 may include the base 110. The base 110 may be arranged to be placed on the bottom 11 of the case 10. The base 110 may be configured to be in contact with the bottom 11 of the case 10. The base 110 may include a shape protruding from the partition 120 in the first direction D1. The base 110 may protrude from a lower end of the partition 120 in the first direction D1. The base 110 may extend along the second direction D2.

The base 110 may include a base body 111. The base 110 may include a plurality of edges for defining the base body 111. For example, the base 110 may include a first edge 1111, a second edge 1112, a third edge 1113, a fourth edge 1114, a fifth edge 1115, a sixth edge 1116, and a seventh edge 1117.

The base 110 may include a corner 112. The corner 112 may be a portion of the base body 111. The corner 112 may include a point where two of the plurality of edges meet and a portion of the base body 111 defined by the two edges.

In an example, the base 110 may include a pair of corners 112. The base 110 may include a first corner 1121 formed by the first edge 1111 and the second edge 1112, and a second corner 1122 formed by the first edge 1111 and the third edge 1113. The first corner 1121 and the second corner 1122 may be spaced apart along the second direction D2. The description of the corner 112 may be applied to both the first corner 1121 and the second corner 1122.

The bracket 100 may include the partition 120. The partition 120 may extend from the base 110 along a third direction D3. The third direction D3 may be a direction that intersects each of the first direction D1 and the second direction D2. For example, the third direction D3 may include a substantially vertical direction (Z direction). The partition 120 may extend upwardly from the base 110. The partition 120 may extend along the second direction D2.

For example, the bracket 100 may include a substantially L-shape.

The bracket 100 may include the insertion hole 130. The insertion hole 130 may be formed in the base 110. In an example, the insertion hole 130 may be formed indented from the first edge 1111 of the base 110. In an example, the insertion hole 130 may be formed to penetrate upper and lower surfaces of the base 110. In an example, a height of the insertion hole 130 along the third direction D3 may be the same as a thickness t of the base 110.

The insertion hole 130 may be configured such that a third coupling portion 17 of the case 10, which will be described later, is insertable. In an example, the bracket 100 may include a plurality of insertion holes 130, and the plurality of insertion holes 130 may be spaced apart substantially along the second direction D2. In the drawings, the bracket 100 is shown to include two insertion holes 130, but the present disclosure is not limited thereto. The insertion hole 130 may be provided as a single unit. The number of insertion holes 130 may correspond to the number of third coupling portions 17.

Referring to FIG. 11, the insertion hole 130 may include a first hole portion 131 and a second hole portion 132. The first hole portion 131 and the second hole portion 132 may be arranged substantially along the first direction D1. The first hole portion 131 may be disposed adjacent to the partition 120 than the second hole portion 132. The insertion hole 130 may be open in a direction from the first hole portion 131 toward the second hole portion 132.

The second hole portion 132 may be extended from the first hole portion 131. The size of the second hole portion 132 may be larger than the size of the first hole portion 131. For example, a length W1 of the first hole portion 131 along the second direction D2 may be smaller than a length W2 of the second hole portion 132 along the second direction D2. Here, the length along the second direction D2 may be based on the maximum length.

The bracket 100 may include a chamfer portion 133. The chamfer portion 133 may be configured to define the second hole portion 132. The chamfer portion 133 may include a shape that tapers in a direction from the second hole portion 132 toward the first hole portion 131. For example, the chamfer portion 133 may extend inclinedly from the first edge 1111.

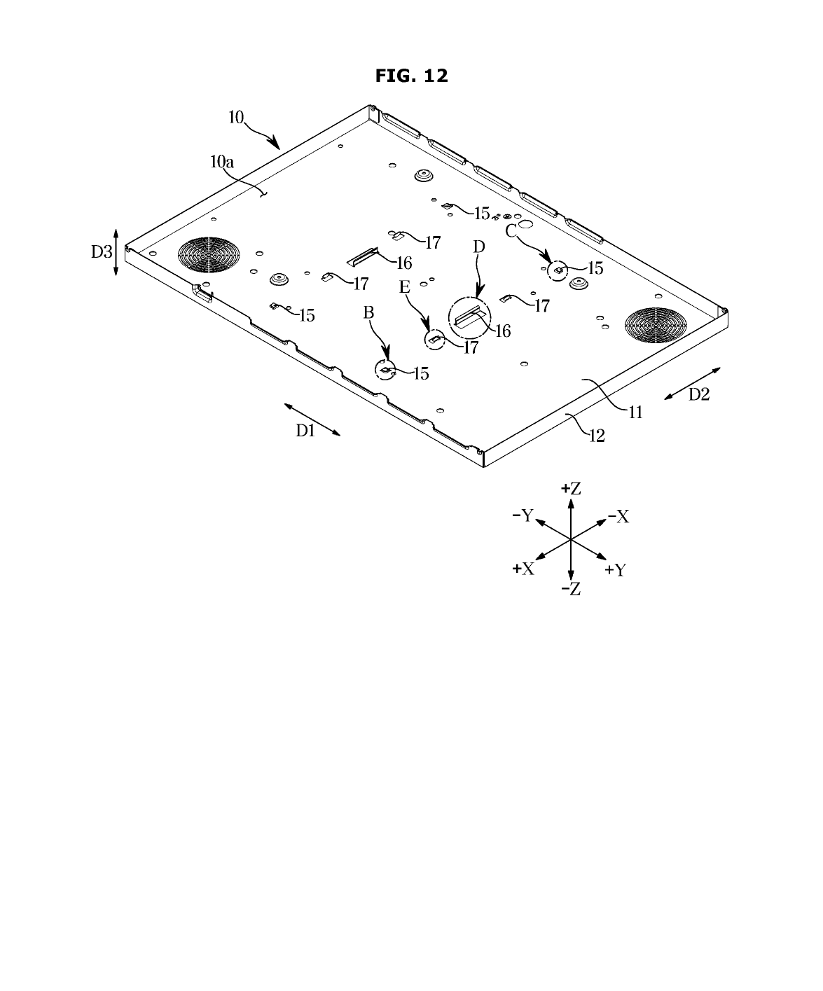

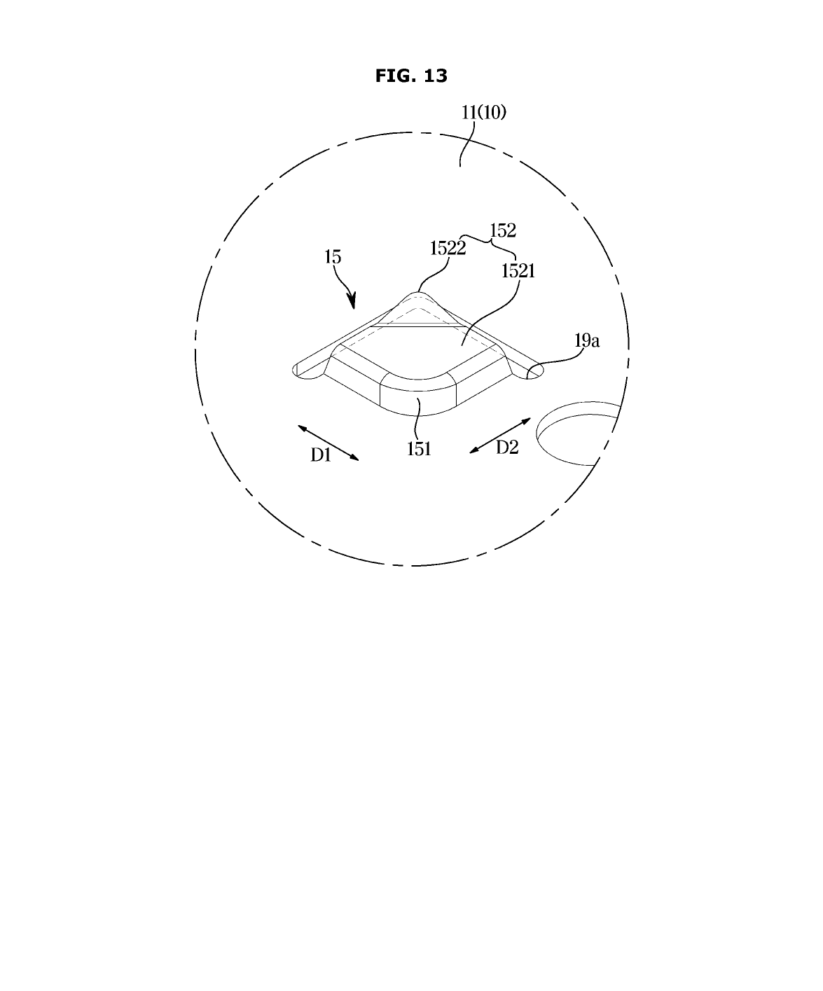

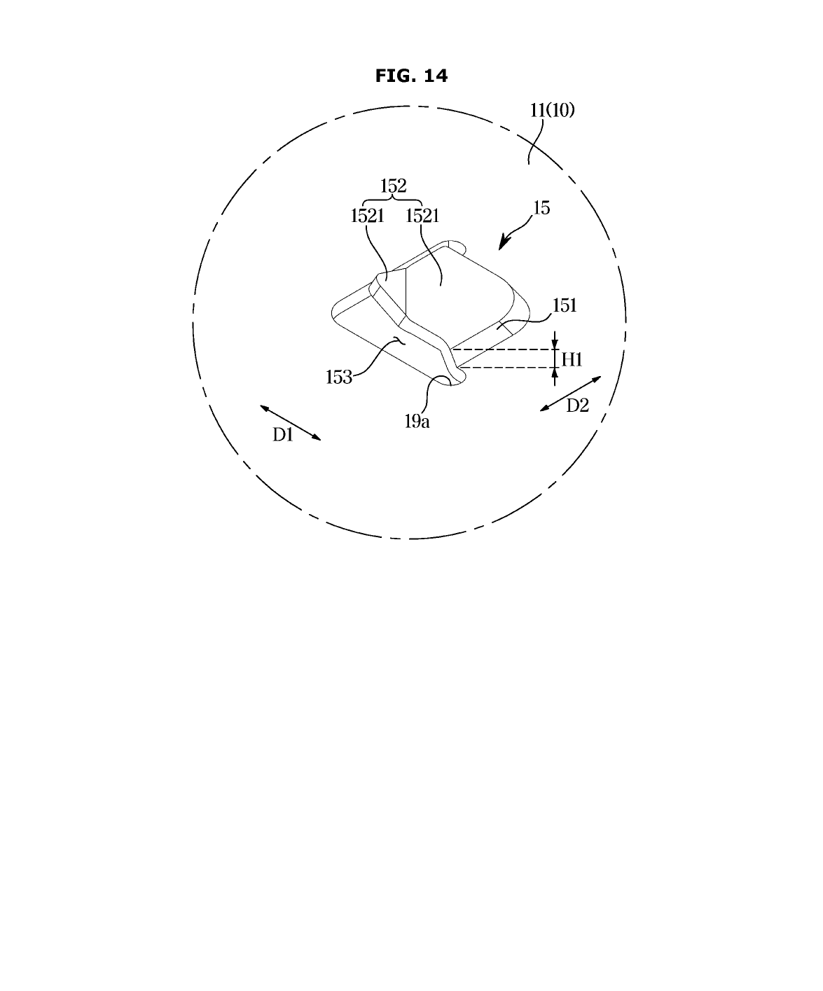

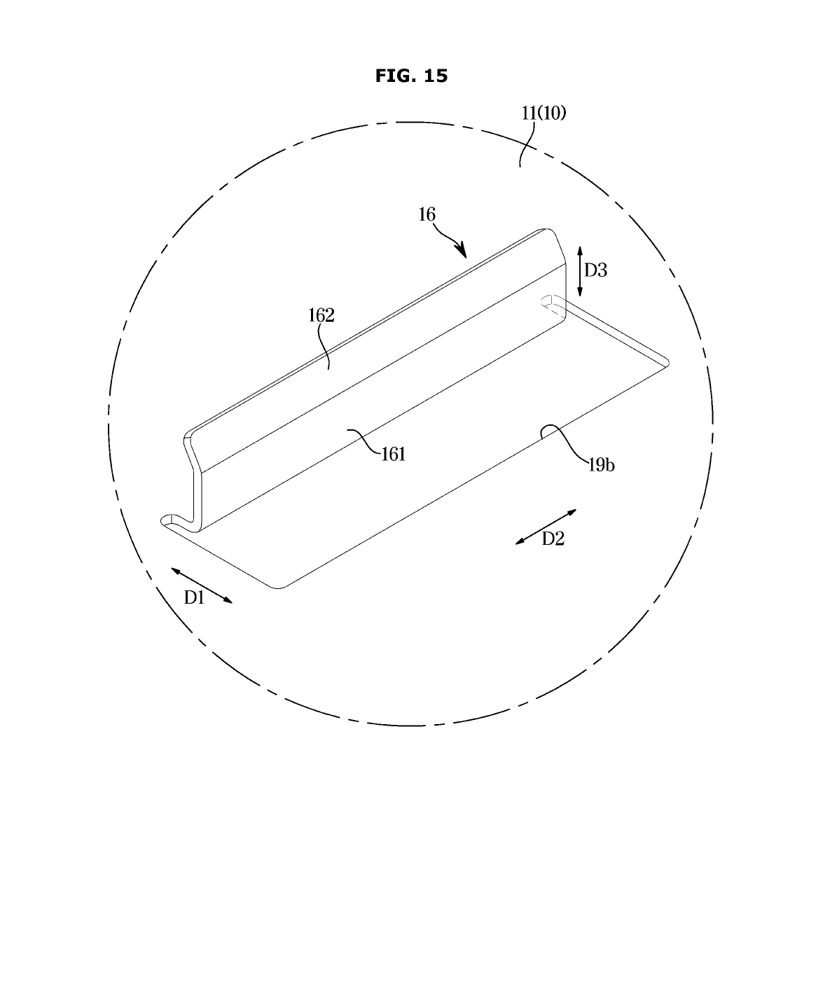

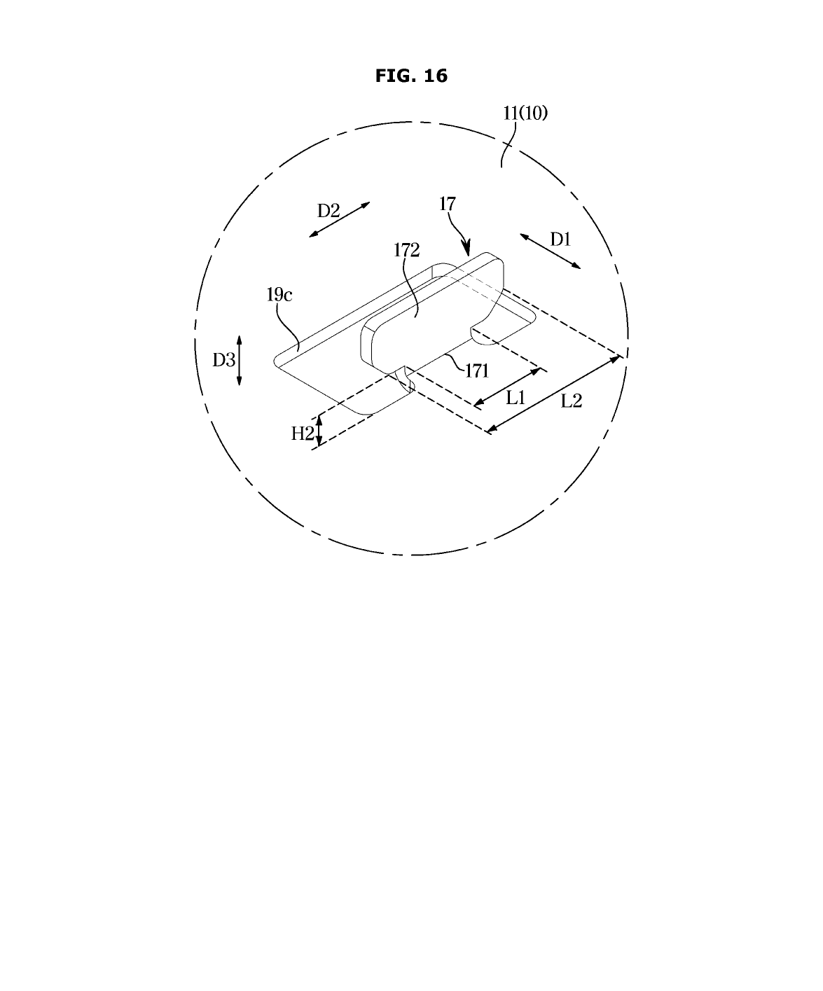

FIG. 12 is a cutaway perspective view of the case according to an embodiment of the present disclosure. FIG. 13 is an enlarged view of portion B shown in FIG. 12. FIG. 14 is an enlarged view of portion C shown in FIG. 12. FIG. 15 is an enlarged view of portion D shown in FIG. 12. FIG. 16 is an enlarged view of portion E shown in FIG. 12.

Referring to FIG. 12, the case 10 may include a plurality of coupling portions 15, 16, and 17. The bracket 100 may be coupled to the plurality of coupling portions 15, 16, and 17. When the bracket 100 is coupled to the plurality of coupling portions 15, 16, and 17, the bracket 100 and the case 10 may be coupled together. The plurality of coupling portions 15, 16, and 17 may fix the bracket 100 to the case 10 and may be configured to restrict the bracket 100 from detaching and/or separating from the case 10.

Referring to FIGS. 12 to 14, the case 10 may include a first coupling portion 15. The first coupling portion 15 may be formed on the bottom 11 of the case 10. In an example, the first coupling portion 15 may be formed by cutting a part 19a of the bottom 11 of the case 10. In an example, the first coupling portion 15 may be formed by lancing. The first coupling portion 15 may protrude from an inner surface of the bottom 11 of the case 10.

The first coupling portion 15 may be configured to be coupleable to the base 110 of the bracket 100. The first coupling portion 15 may be configured to correspond to the corner 112 of the base 110 (see FIG. 10). The first coupling portion 15 may be configured to fixe the corner 112 of the base 110. The first coupling portion 15 may cover the corner 112 of the base 110 to restrict the movement of the base 110 along the first direction D1, the second direction D2, and a third direction (e.g., the vertical direction).

For example, two first coupling portions 15 may be provided to fix one bracket 100. One of the two first coupling portions 15 may fix the first corner 1121, and the other of the two first coupling portions 15 may fix the second corner 1122. However, the present disclosure is not limited to the example described above, and the case 10 may include one first coupling portion 15.

The first coupling portion 15 may include a first cover portion 151. The first cover portion 151 may extend upwardly from the bottom 11 of the case 10. The first cover portion 151 may protrude upwardly from the bottom 11 of the case 10. The first cover portion 151 may have a shape extending substantially along the first direction D1 and the second direction D2. In an example, the second cover portion 152 may include a substantially L-shape.

The first coupling portion 15 may include a second cover portion 152. The second cover portion 152 may extend from the first cover portion 151. The second cover portion 152 may extend from the first cover portion 151 substantially parallel to the bottom 11 of the case 10. The second cover portion 152 may have a shape extending substantially along the first direction D1 and the second direction D2. In an example, the second cover portion 152 may have a substantially plate shape.

For example, the second cover portion 152 may include a cover body 1521 and a bent portion 1522. The cover body 1521 may be configured to be parallel to the bottom 11 of the case 10. The bent portion 1522 may be configured to be bent from the cover body 1521. The bent portion 1522 may include a shape inclined upwardly from the cover body 1521. The corner 112 of the base 110 may be guided by the bent portion 1522 to easily enter the cover body 1521 side.

The first coupling portion 15 may include an insertion groove 153. The insertion groove 153 may be formed by the first cover portion 151 and the second cover portion 152. The insertion groove 153 may be configured such that the corner 112 of the base 110 is insertable. In an example, the second cover portion 152 may have the bent portion 1522, so the entrance of the insertion groove 153 may be enlarged, and the corner 112 of the base 110 may be more easily inserted into the insertion groove 153.

Referring to FIGS. 12 and 15, the case 10 may include the second coupling portion 16. The second coupling portion 16 may be formed on the bottom 11 of the case 10. In an example, the second coupling portion 16 may be formed by cutting and bending a part 19b of the bottom 11 of the case 10. The second coupling portion 16 may protrude upwardly from the bottom 11 of the case 10. In an example, the second coupling portion 16 may be configured to stand upright on the bottom 11 of the case 10.

The second coupling portion 16 may be configured to be coupleable to the partition 120 of the bracket 100. The second coupling portion 16 may be configured to correspond to the partition 120. The second coupling portion 16 may be configured to support the partition 120. The second coupling portion 16 may be in contact with the partition 120 to restrict the movement of the partition 120 along the first direction D1. For example, the second coupling portion 16 may be configured to support a substantially central portion of the partition 120. For example, the second coupling portion 16 may be positioned at a substantially central portion of the length of the bottom 11 of the case 10 along the second direction D2. However, the present disclosure is not limited to the example described above. As long as the second coupling portion 16 may support the partition 120, the second coupling portion 16 may be provided at different positions, and the number of second coupling portions 16 is also not limited.

For example, the second coupling portion 16 may include a first extension portion 161 extending from the bottom 11 of the case 10, and a second extension portion 162 extending from the first extension portion 161. The first extension portion 161 may be bent from the bottom 11 of the case 10. The second extension portion 162 may extend upwardly from the first extension portion 161. The second extension portion 162 may extend inclinedly from the first extension portion 161.

For example, the second coupling portion 16 may include an elastically deformable material. During the coupling of the bracket 100 to the case 10, the second coupling portion 16 may be elastically deformed. When the bracket 100 is completely coupled to the case 10, the elastically deformed second coupling portion 16 may be restored to its original state.

Referring to FIGS. 12 and 16, the case 10 may include the third coupling portion 17. The third coupling portion 17 may be formed on the bottom 11 of the case 10. In an example, the third coupling portion 17 may be formed by cutting and bending a part 19c of the bottom 11 of the case 10. The third coupling portion 17 may protrude upwardly from the bottom 11 of the case 10. The third coupling portion 17 may be spaced apart from the first coupling portion 15 along the second direction D2.

The third coupling portion 17 may be configured to be coupleable to the base 110 of the bracket 100. The third coupling portion 17 may be configured to correspond to the base body 111 of the base 110 (see FIG. 10). The third coupling portion 17 may be configured to fix the base 110. The third coupling portion 17 may be configured such that the insertion hole 130 is insertable. The third coupling portion 17 may be inserted into the insertion hole 130 to restrict the movement of the base 110 along the second direction D2 and the third direction D3 (e.g., the vertical direction).

For example, the third coupling portions 17 may be provided in a plurality, and the plurality of third coupling portions 17 may be spaced apart along the second direction D2. However, the present disclosure is not limited to the example described above, and the case 10 may include one third coupling portion 17. The number of third coupling portions 17 is not limited. The number of third coupling portions 17 may correspond to the number of insertion holes 130 (see FIG. 10).

The third coupling portion 17 may include a first rib portion 171. The first rib portion 171 may extend upwardly from the bottom 11 of the case 10. The first rib portion 171 may be bent from the bottom 11 of the case 10.

The third coupling portion 17 may include a second rib portion 172. The second rib portion 172 may extend upwardly from the first rib portion 171.

The size of the second rib portion 172 may be larger than the size of the first rib portion 171. For example, a length L2 of the second rib portion 172 along the second direction D2 may be larger than a length L1 of the first rib portion 171 along the first direction D1. Here, the length along the second direction D2 may be based on the maximum length.

For example, the third coupling portion 17 may include a substantially T-shape.

Meanwhile, the ordinal numbers “first”, “second”, and “third” of the first coupling portion 15, the second coupling portion 16, and the third coupling portion 17 do not limit their configuration.

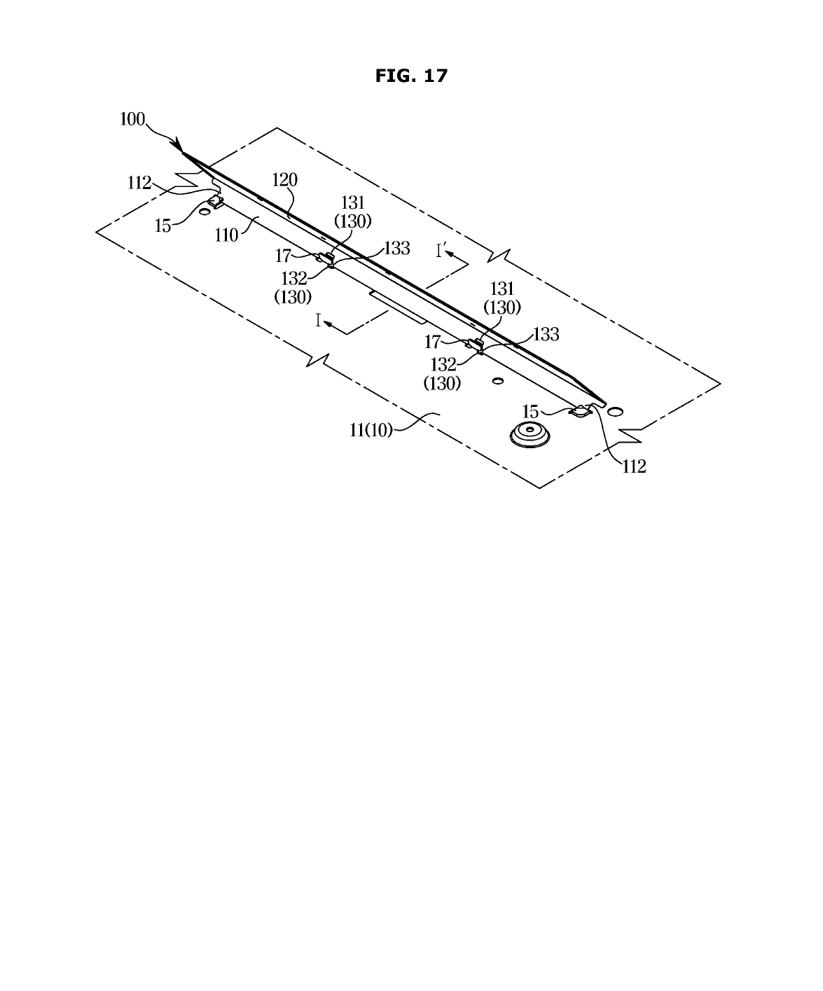

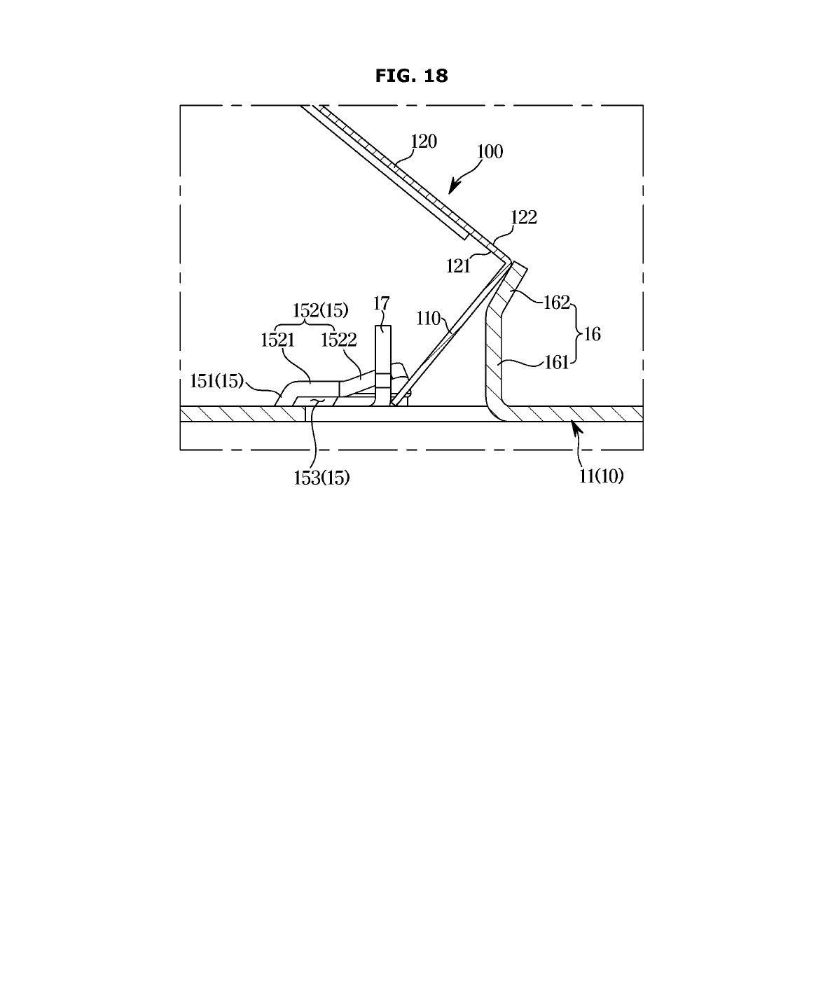

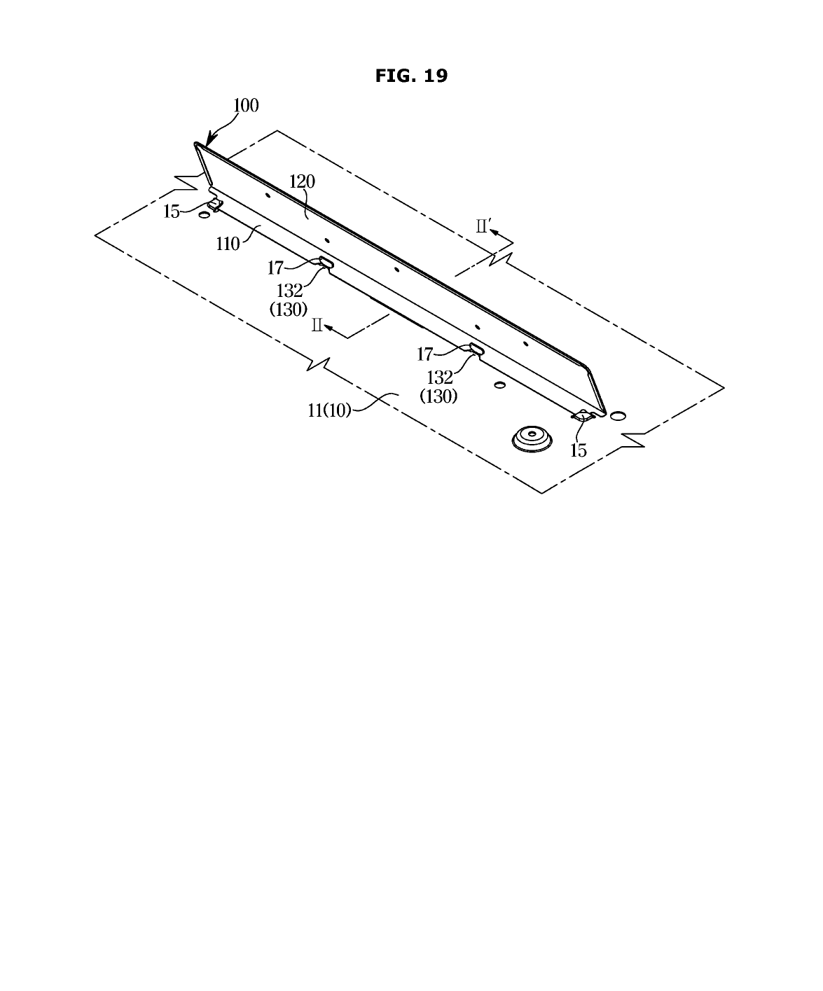

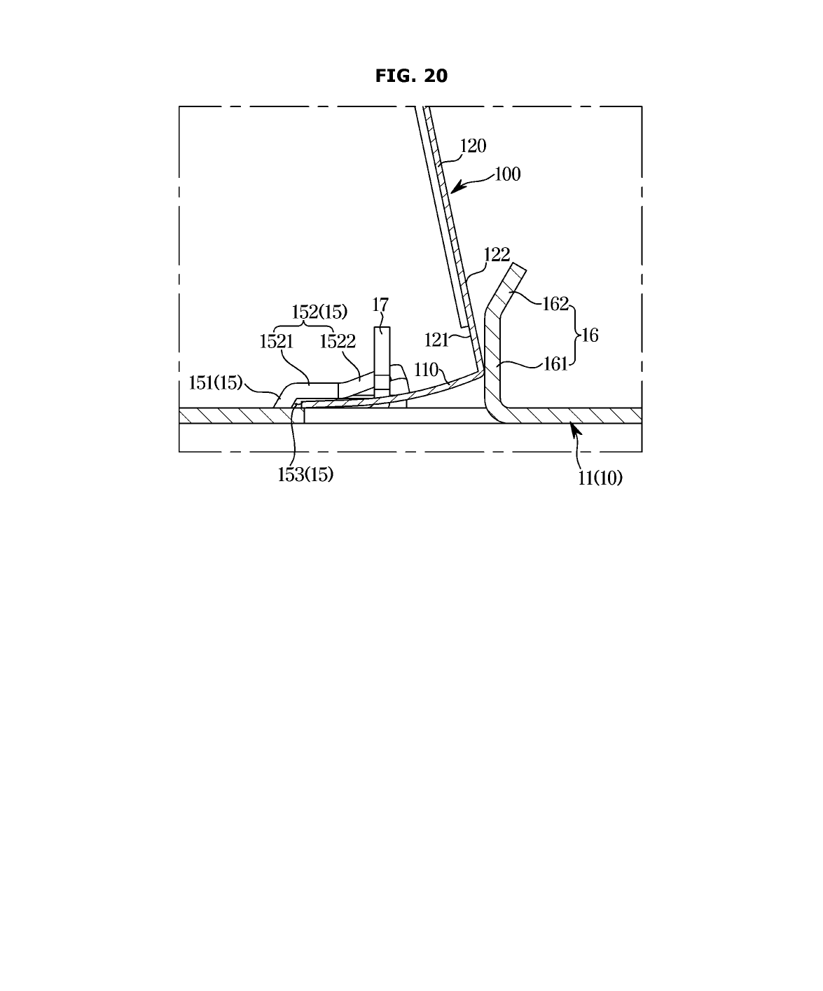

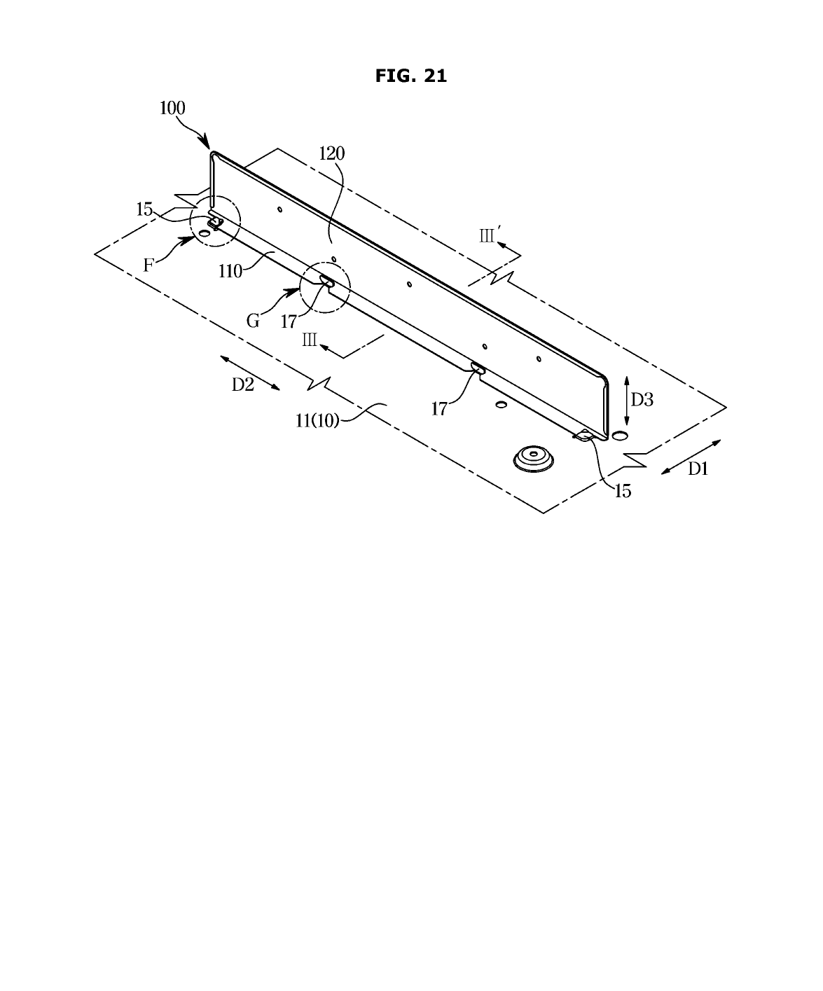

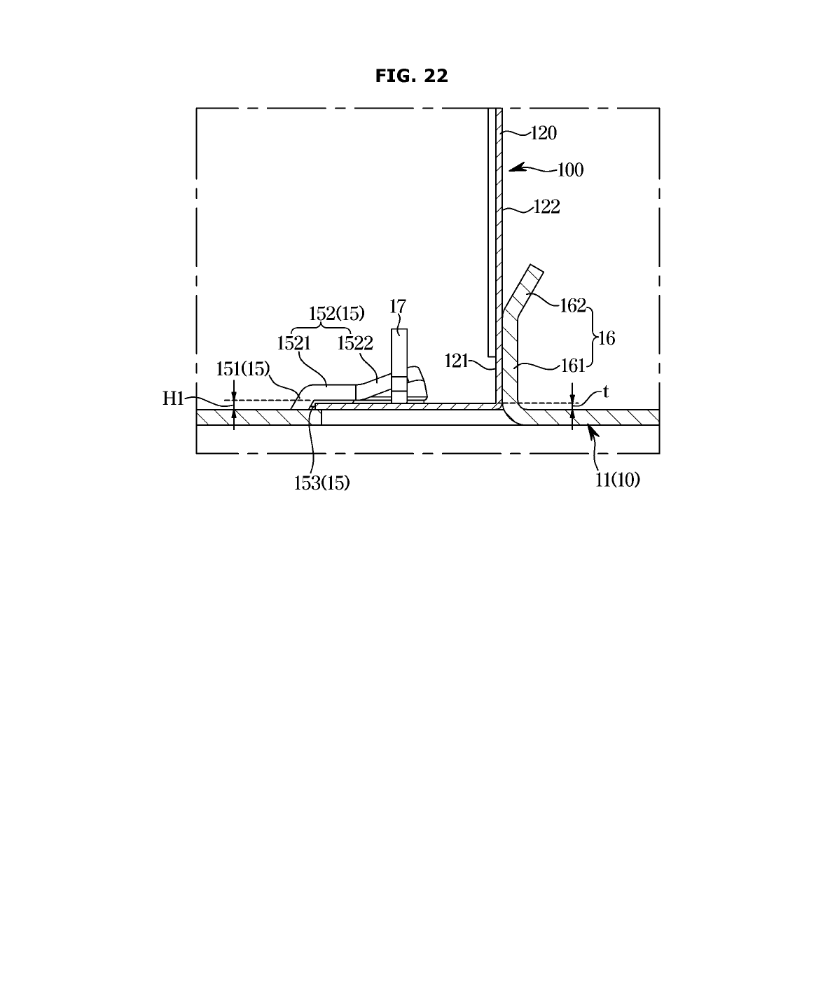

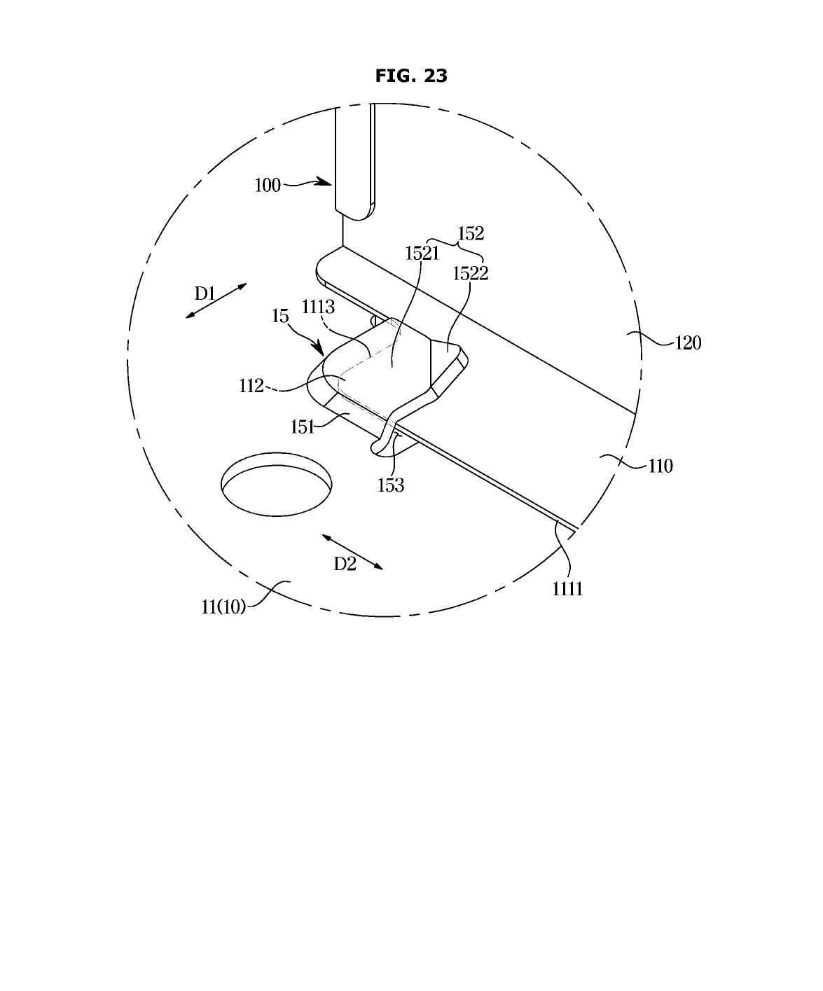

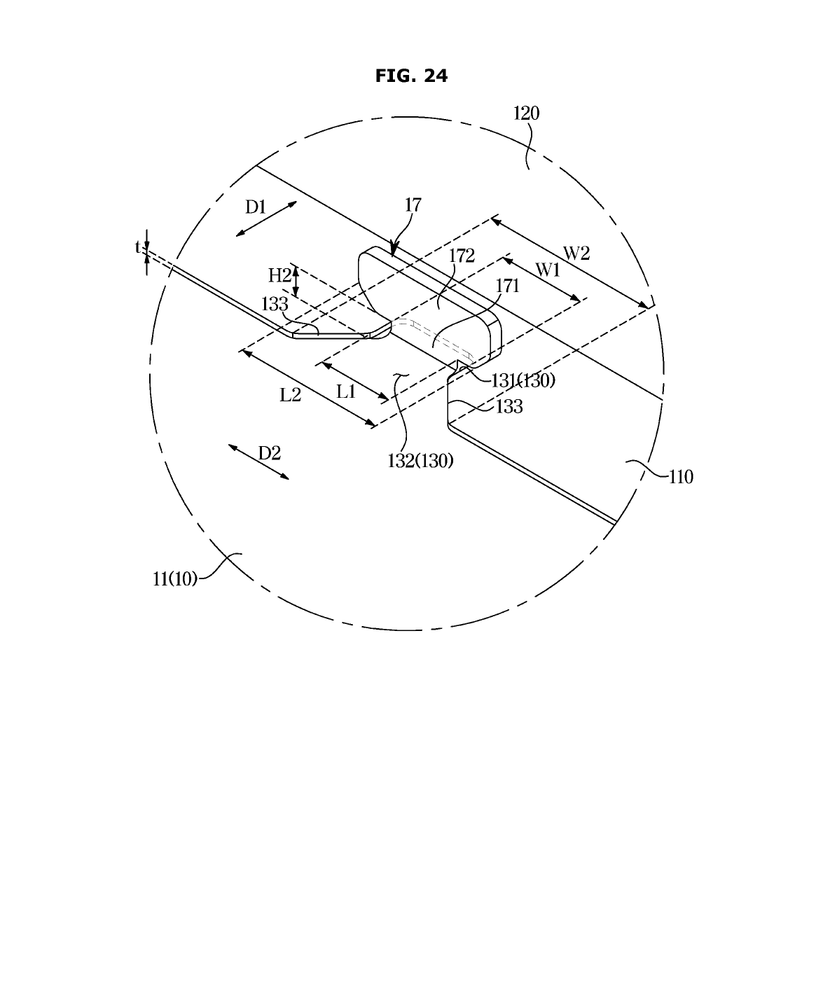

FIG. 17 is a view illustrating a process of assembling the case and the bracket according to an embodiment of the present disclosure. FIG. 18 is a cross-sectional view taken along line I-I' shown in FIG. 17. FIG. 19 is a view illustrating a process of assembling the case and the bracket according to an embodiment of the present disclosure. FIG. 20 is a cross-sectional view taken along line II-II' shown in FIG. 19. FIG. 21 is a view illustrating a process of assembling the case and the bracket according to an embodiment of the present disclosure. FIG. 22 is a cross-sectional view taken along line III-III' shown in FIG. 21. FIG. 23 is an enlarged view of portion F shown in FIG. 21. FIG. 24 is an enlarged view of portion G shown in FIG. 21.

Referring to FIGS. 17 and 18, the base 110 of the bracket 100 may be disposed facing the first coupling portion 15 and the third coupling portion 17 of the case 10. The corner 112 of the base 110 may be disposed corresponding to the insertion groove 153 of the first coupling portion 15. The corner 112 of the base 110 may be arranged to enter toward the insertion groove 153 of the first coupling portion 15. The insertion hole 130 may be disposed corresponding to the third coupling portion 17. In an example, the second hole portion 132 of the insertion hole 130 may be disposed corresponding to the third coupling portion 17. The bracket 100 may be inclined relative to the bottom 11 of the case 10 so as to be coupled to the case 10. The base 110 may be inclined relative to the bottom 11 of the case 10.

Referring to FIGS. 19 and 20, the base 110 of the bracket 100 may move further toward the first coupling portion 15 and the third coupling portion 17 of the case 10. The corner 112 of the base 110 may enter the inside of the insertion groove 153 of the first coupling portion 15. The corner 112 of the base 110 may be inserted into the insertion groove 153 of the first coupling portion 15. The third coupling portion 17 may be inserted into the insertion hole 130. In an example, the third coupling portion 17 may be arranged to be positioned in the first hole portion 131 through the second hole portion 132. In other words, as the base 110 moves, the third coupling portion 17 may be arranged to be positioned in the first hole portion 131 via the second hole portion 132. The chamfer portion 133 may be configured to guide the third coupling portion 17 entering the second hole portion 132 to the first hole portion 131. The bracket 100 may be rotated such that the base 110 faces the bottom 11 of the case 10. The inclination between the base 110 and the bottom 11 of the case 10 may be reduced. The bracket 100 may be elastically deformed while being coupling to the case 10. In the process of coupling the bracket 100 and the case 10, the second coupling portion 16 may also be elastically deformed.

Referring to FIGS. 21 to 24, the bracket 100 may be coupled to the case 10. The corner 112 of the base 110 may be coupled to the first coupling portion 15. The partition 120 of the base 110 may be coupled to the second coupling portion 16. The insertion hole 113 of the base 110 may be coupled to the third coupling portion 17. The bracket 100 may be rotated such that the base 110 is placed on the bottom 11 of the case 10. After the corner 112 of the base 110 is fixed to the first coupling portion 15, the partition 120 may be supported by the second coupling portion 16 as the bracket 100 is rotated such that the base 110 is seated on the bottom 11 of the case 10. After the third coupling portion 17 is fixed to the insertion hole 130, the partition 120 may be supported by the second coupling portion 16 as the bracket 100 is rotated such that the base 110 is seated on the bottom 11 of the case 10. After the base 110 is coupled to the first coupling portion 15 and the third coupling portion 17, the partition 120 may be coupled to the second coupling portion 16 as the bracket 100 is rotated such that the base 110 is seated on the bottom 11 of the case 10.

After the coupling of the bracket 100 and the case 10 is completed, the bracket 100, which was elastically deformed during the coupling of the bracket 100 and the case 10, may be restored to its original state. When the second coupling portion 16 is elastically deformed during the coupling of the bracket 100 and the case 10, the elastically deformed second coupling portion 16 may be restored to its original state.

Referring to FIG. 22, while the bracket 100 is coupled to the case 10, the second coupling portion 16 may be configured to support the partition 120. The partition 120 may include a first surface 121 adjacent to the base and a second surface 122 opposite to the first surface 121. While the bracket 100 is coupled to the case 10, the second coupling portion 16 may be provided to be in contact with the second surface 122 of the partition 120. The first extension portion 161 of the second coupling portion 16 may be provided to be in contact with the second surface 122 of the partition 120. While the bracket 100 is coupled to the case 10, the second coupling portion 16 may restrict the movement of the bracket 100 along the first direction D1. When the bracket 100 moves in the coupled state with the case 10, the partition 120 may interfere with the second coupling portion 16.

Referring to FIG. 23, while the bracket 100 is coupled to the case 10, the first coupling portion 15 may be provided to fix the corner 112 of the base 110. In an example, two first coupling portions 15 may fix the pair of corners 112 (1121 and 1122, see FIG. 10) of the base 110, respectively. While the bracket 100 is coupled to the case 10, the corner 112 of the base 110 may be inserted into the insertion groove 153. The thickness t of the base 110 may be equal to or less than a height H1 of the insertion groove 153 in the vertical direction (see FIG. 22). This may allow the corner 112 of the base 110 to be insertable into the insertion groove 153. While the bracket 100 is coupled to the case 10, the first cover portion 151 may be provided to cover the edges forming the corner 112 (in FIG. 23, a portion of the first edge 1111 and a portion of the third edge 1113). While the bracket 100 is coupled to the case 10, the second cover portion 152 may be provided to cover the upper surface. While the bracket 100 is coupled to the case 10, the first coupling portion 15 may restrict the movement of the bracket 100 along the first direction D1, the second direction D2, and the third direction D3. In an example, the first cover portion 151 may restrict the movement of the bracket 100 in the first direction D1 and the second direction D2. In an example, the second cover portion 152 may restrict the movement of the bracket 100 along the third direction D3. When the bracket 100 moves in the coupled state with the case 10, the corner 112 of the base 110 may interfere with the first coupling portion 15.

Referring to FIG. 24, while the bracket 100 is coupled to the case 10, the third coupling portion 17 may be provided to fix the base 110. The third coupling portion 17 may be inserted into the insertion hole 130 and provided to fix the base body 111. While the bracket 100 is coupled to the case 10, the third coupling portion 17 may be inserted into the insertion hole 130. While the bracket 100 is coupled to the case 10, the first rib portion 171 of the third coupling portion 17 may be positioned in the first hole portion 131. While the bracket 100 is coupled to the case 10, the second rib portion 172 of the third coupling portion 17 may be positioned on the upper surface of the base 110. While the bracket 100 is coupled to the case 10, the third coupling portion 17 may restrict the movement of the bracket 100 along the second direction D2 and the third direction D3. When the bracket 100 moves in the coupled state with the case 10, the base 110 may interfere with the third coupling portion 17.

Meanwhile, a height H2 of the first rib portion 171 in the vertical direction may be equal to or greater than the thickness t of the base 110. The length L2 of the second rib portion 172 along the second direction D2 may be greater than the length L1 of the first rib portion 171 along the second direction D2. The length L1 of the first rib portion 171 along the second direction D2 may be equal to or less than the length W1 of the first hole portion 131 along the second direction D2. The length L1 of the first rib portion 171 along the second direction D2 may be less than the length W2 of the second hole portion 132 along the second direction D2. This may allow the first rib portion 171 of the third coupling portion 17 to be inserted into the first hole portion 131 through the second hole portion 132. The first rib portion 171 positioned in the first hole portion 131 may interfere with the edges forming the first hole portion 131. In an example, the first rib portion 171 may be positioned within the insertion hole 130 (particularly, the first hole portion 131) and configured to restrict the movement of the base 110 along the second direction D2. While the first rib portion 171 is positioned in the first hole portion 131, the second rib portion 172 may be positioned above the base 110. In an example, the second rib portion 172 may be positioned above the base 110 and configured to restrict the movement of the base 110 along the third direction D3 (e.g., the vertical direction).

As described above, according to an embodiment of the present disclosure, the bracket 100 may be coupled to the case 10 without a separate tool or a separate fastening member. The plurality of coupling portions 16, 17, and 18 of the case 10 may fix or support the bracket 100. In a state in which the bracket 100 is coupled to the case 10, the plurality of coupling portions 16, 17, and 18 may prevent/reduce the bracket 100 from separating or detaching from the case 10. Accordingly, the bracket 100 may be stably coupled to the case 10. The bracket 100 does not deviate from between the first and second circuit boards 80 and 90 and may effectively prevent/reduce EMI.

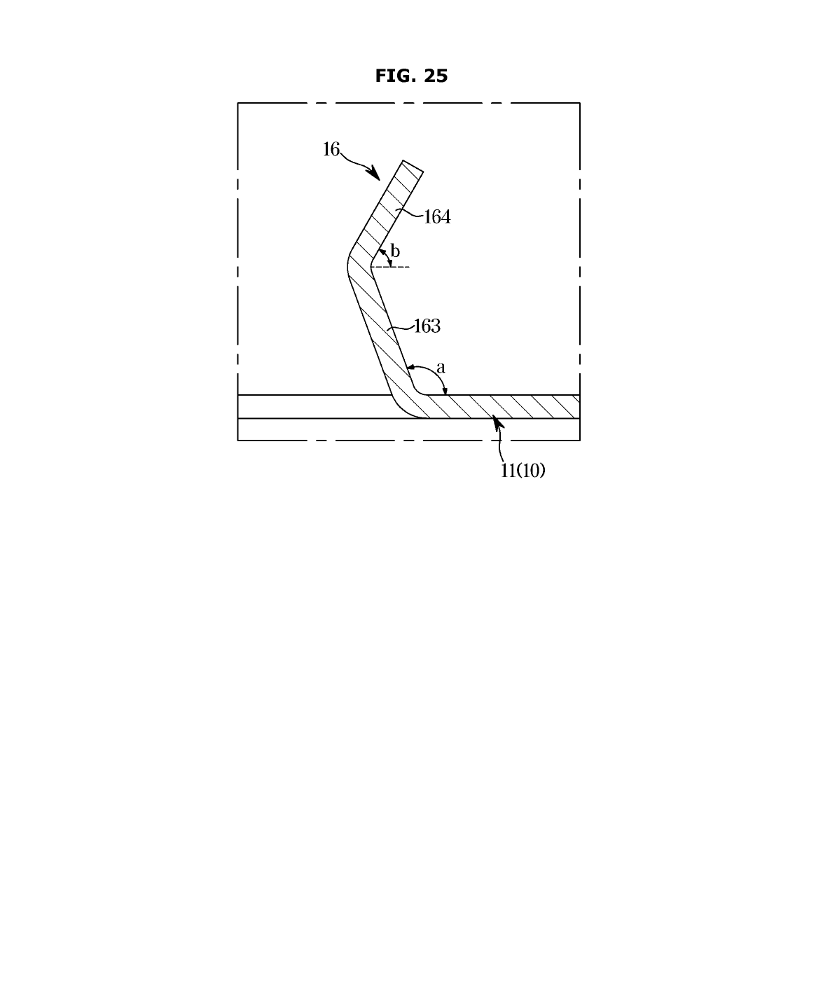

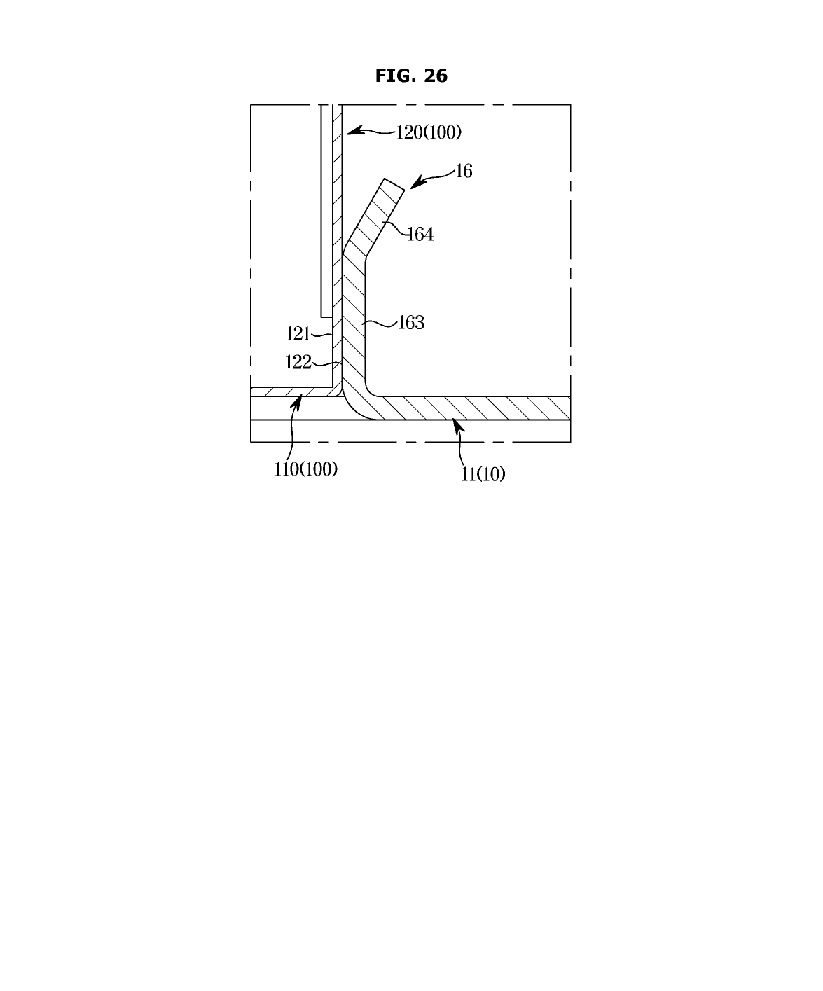

FIG. 25 is a cross-sectional view of a portion of the case according to an embodiment of the present disclosure. FIG. 26 is a cross-sectional view illustrating a state in which the bracket is coupled to the case shown in FIG. 25, according to an embodiment of the present disclosure.

Compared to the second coupling portion 16 shown in FIG. 15, the second coupling portion 16 shown in FIGS. 25 and 26 may not include the first extension portion 161 and the second extension portion 162, but may include a third extension portion 163 and a fourth extension portion 164. Compared to the second coupling portion 16 shown in FIG. 15, the second coupling portion 16 shown in FIGS. 25 and 26 may perform substantially the same function, with only its shape being different.

The third extension portion 163 may extend upwardly from the bottom 11 of the case 10. The third extension portion 163 may be configured to be inclined from the bottom 11 of the case 10. The fourth extension portion 164 may extend upwardly from the third extension portion 163. The fourth extension portion 164 may be configured to be inclined from the third extension portion 163. For example, an inclination direction of the third extension portion 163 and an inclination direction of the fourth extension portion 164 may be different. The third extension portion 163 may be configured to form an obtuse angle a relative to the bottom 11 of the case 10. The fourth extension portion 164 may be configured to form an acute angle b relative to the bottom 11 of the case 10. While the bracket 100 is coupled to the case 10, the third extension portion 163 may be configured to be in contact with the partition 120. While the bracket 100 is coupled to the case 10, the third extension portion 163 may be configured to support the second surface 122 of the partition 120.

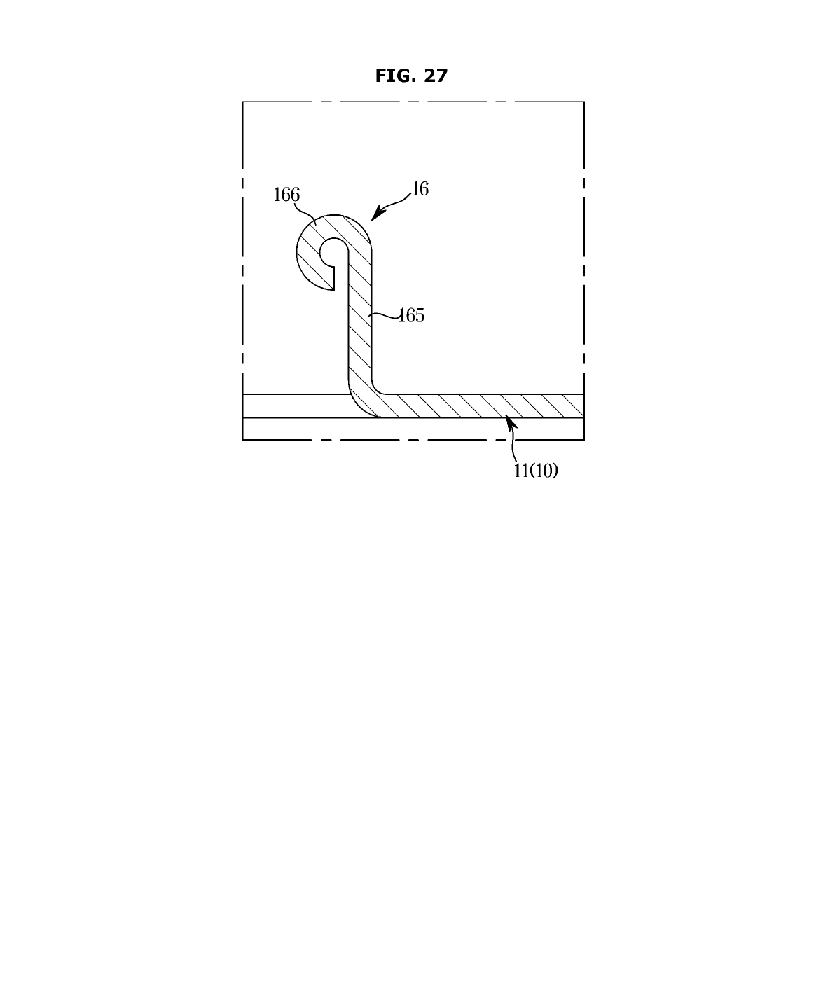

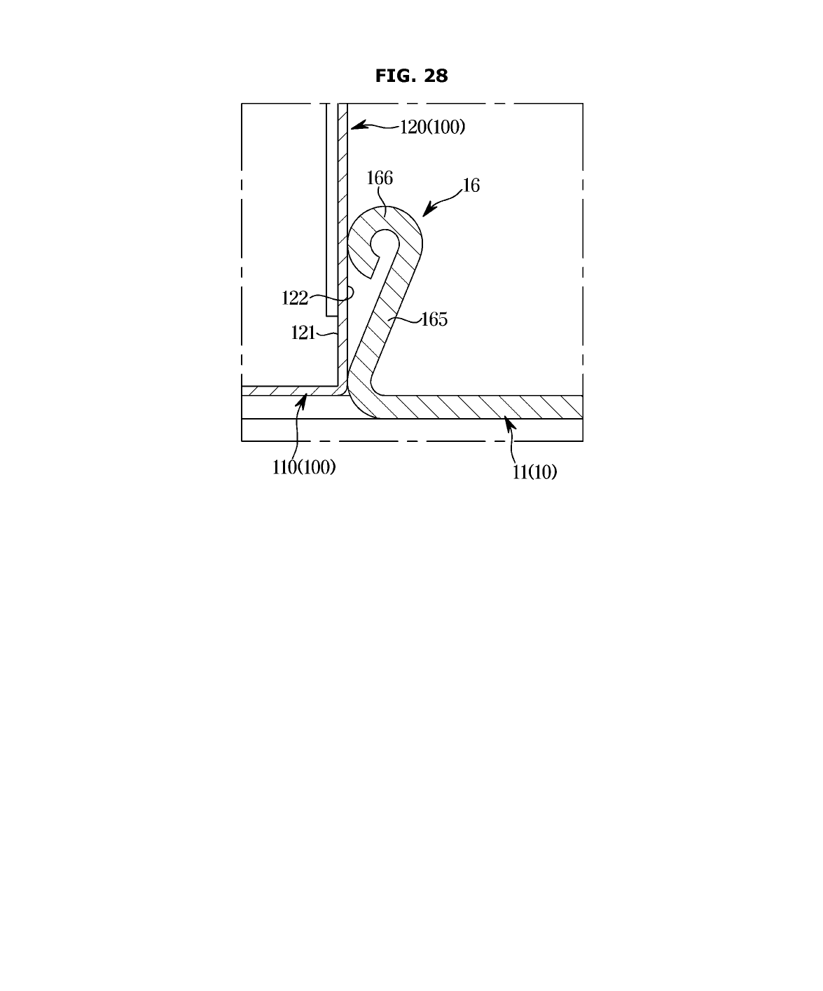

FIG. 27 is a cross-sectional view of a portion of the case according to an embodiment of the present disclosure. FIG. 28 is a cross-sectional view illustrating a state in which the bracket is coupled to the case shown in FIG. 27, according to an embodiment of the present disclosure.

Compared to the second coupling portion 16 shown in FIG. 15, the second coupling portion 16 shown in FIGS. 27 and 28 may not include the first extension portion 161 and the second extension portion 162, but may include a fifth extension portion 165 and a sixth extension portion 166. Compared to the second coupling portion 16 shown in FIG. 15, the second coupling portion 16 shown in FIGS. 27 and 28 may perform substantially the same function, with only its shape being different.

The fifth extension portion 165 may extend upwardly from the bottom 11 of the case 10. In an example, the fifth extension portion 165 may protrude to substantially intersect the bottom 11 of the case 10. The sixth extension portion 166 may be configured to be curved from the fifth extension portion 165. The sixth extension portion 166 may include a shape wound roundly from an upper end of the sixth extension portion 165 (e.g., a hook-like shape). While the bracket 100 is coupled to the case 10, the fifth extension portion 165 may be bent. While the bracket 100 is coupled to the case 10, the sixth extension portion 166 may be configured to be in contact with the partition 120. While the bracket 100 is coupled to the case 10, the sixth extension portion 166 may be configured to support the second surface 122 of the partition 120.

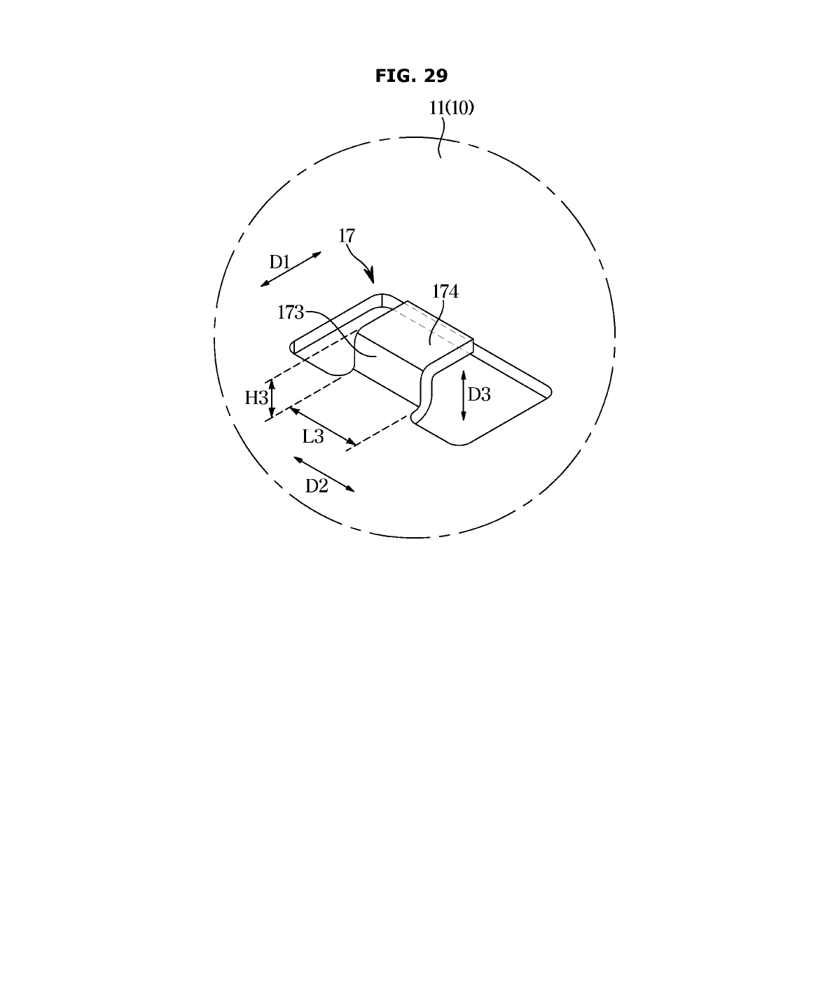

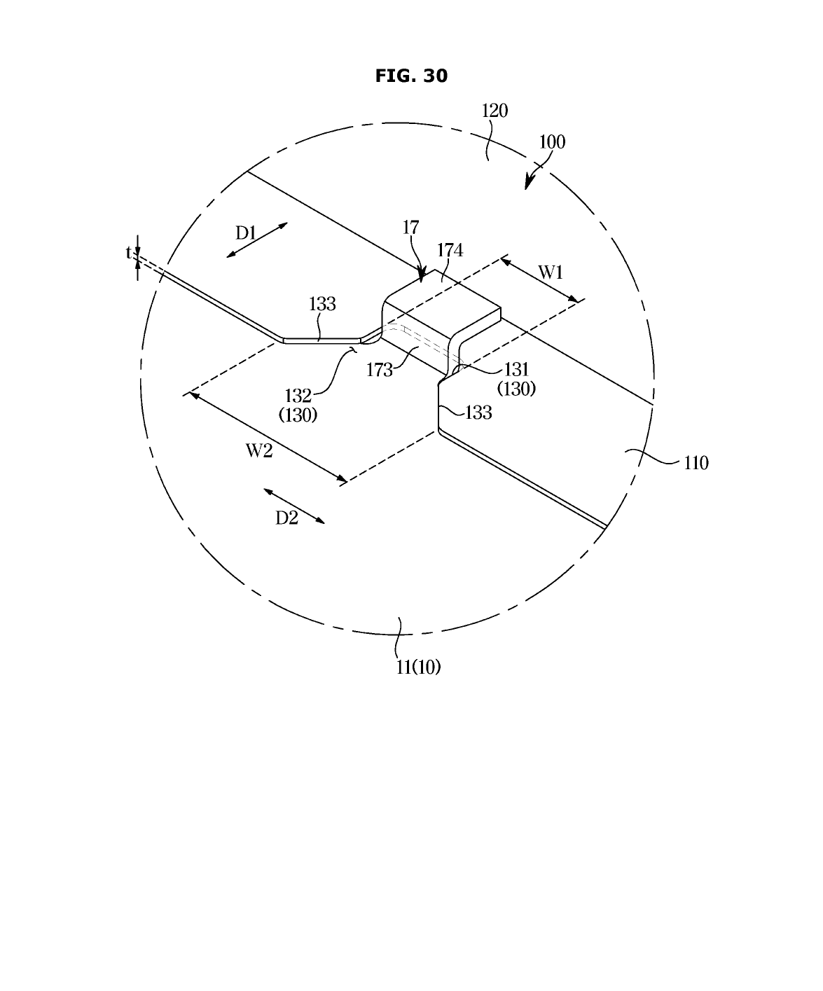

FIG. 29 is a cross-sectional view of a portion of the case according to an embodiment of the present disclosure. FIG. 30 is a cross-sectional view illustrating a state in which the bracket is coupled to the case shown in FIG. 29, according to an embodiment of the present disclosure.

Compared to the third coupling portion 17 shown in FIG. 16, the third coupling portion 17 shown in FIGS. 29 and 30 may not include the first rib portion 171 and the second rib portion 172, but may include a third rib portion 173 and a fourth rib portion 174. Compared to the third coupling portion 17 shown in FIG. 16, the third coupling portion 17 shown in FIGS. 29 and 30 may perform substantially the same function, with only its shape being different.

The third rib portion 173 may extend upwardly from the bottom 11 of the case 10. In an example, the third rib portion 173 may protrude to substantially intersect the bottom 11 of the case 10. The fourth rib portion 174 may be bent from the third rib portion 173. The fourth rib portion 174 may protrude from the third rib portion 173 substantially in the first direction D1. The fourth rib portion 174 may protrude to substantially intersect the third rib portion 173. While the bracket 100 is coupled to the case 10, the third rib portion 173 may be inserted into the insertion hole 130. As the bracket 100 is coupled to the case 10, the third rib portion 173 may be arranged to be positioned in the first hole portion 131 through the second hole portion 132. While the bracket 100 is coupled to the case 10, the fourth rib portion 174 may extend toward the partition 120. While the bracket 100 is coupled to the case 10, the fourth rib portion 174 may be positioned above the upper surface of the base 110.

Meanwhile, a height H3 of the third rib portion 173 in the vertical direction may be equal to or greater than the thickness t of the base 110. A length L3 of the third rib portion 173 along the second direction D2 may be equal to or less than the length W1 of the first hole portion 131 along the second direction D2. The length L3 of the third rib portion 173 along the second direction D2 may be less than the length W2 of the second hole portion 132 along the second direction D2. Accordingly, the third rib portion 173 of the third coupling portion 17 may be inserted into the first hole portion 131 through the second hole portion 132. The third rib portion 173 positioned in the first hole portion 131 may interfere with the edges forming the first hole portion 131. In an example, the third rib portion 173 may be positioned within the insertion hole 130 (particularly, the first hole portion 131) and configured to restrict the movement of the base 110 along the second direction D2. While the third rib portion 173 is positioned in the first hole portion 131, the fourth rib portion 174 may be disposed above the base 110. In an example, the second rib portion 172 may be disposed above the base 110 and configured to restrict the movement of the base 110 along the third direction D3 (e.g., a vertical direction).

The cooking apparatus 1 according to an embodiment of the present disclosure may include: the case 10; the cooking plate 20 mountable on the case 10; the induction heating coil 30 disposed inside the case 10; the first circuit board 80 disposed inside the case 10 and configured to remove and/or reduce noise included in current supplied from an external power source; the second circuit board 90 disposed inside the case 10 and configured to drive the induction heating coil 30; and the bracket 100 coupleable to the case 10 to be disposed between the first and second circuit boards 80 and 90, and configured to prevent and/or reduce EMI. The bracket 100 may include the base 110 provided to be placed on the bottom 11 of the case, and the partition 120 extending upwardly from the base 110. The case 10 may include the first coupling portion 15 formed on the bottom 11 of the case and configured to fix the corner 112 of the base 110 while the bracket is coupled to the case. The case 10 may include the second coupling portion 16 formed on the bottom 11 of the case and configured to support the partition 120 while the bracket is coupled to the case.

The first and second circuit boards 80 and 90 may be arranged along the first direction D1. The base 110 may include a shape protruding from the partition 120 in the first direction D1. The partition 120 may include a shape extending along the second direction D2 intersecting the first direction.

The first coupling portion 15 may include the first cover portion 151 extending upwardly from the bottom 11 of the case. The first cover portion 151 may be configured to cover edges forming the corner 112 of the base while the bracket is coupled to the case. The first coupling portion 15 may include the second cover portion 152 extending from the first cover portion 151. The second cover portion 152 may be configured to cover an upper surface of the corner 112 while the bracket is coupled to the case. The first coupling portion 15 may include the insertion groove 153 formed by the first cover portion 151 and the second cover portion 152 and into which the corner 112 is insertable.

The partition 120 may include the first surface 121 adjacent to the base, and the second surface 122 opposite to the first surface. The second coupling portion 16 may be configured to be in contact with the second surface 122 of the partition 120 while the bracket is coupled to the case.

The case 10 may further include the third coupling portion 17 formed on the bottom 11 of the case and spaced apart from the first coupling portion 15 along the second direction D2. The third coupling portion 17 may be configured to fix the base 110 while the bracket is coupled to the case.

The third coupling portion 17 may include the first rib portion 171 extending upwardly from the bottom 11 of the case. The third coupling portion 17 may include the second rib portion 172 extending upwardly from the first rib portion 171 and disposed on an upper surface of the base while the bracket is coupled to the case.

The length L2 of the second rib portion 172 along the second direction D2 may be greater than the length L1 of the first rib portion 171 along the second direction D2.

The height H2 of the first rib portion 171 in the vertical direction may be equal to or greater than the thickness t of the base 110.

The bracket 100 may include the insertion hole 130 formed in the base 110. The insertion hole 130 may be configured such that the third coupling portion 17 is insertable.

The insertion hole 130 may include the first hole portion 131 and the second hole portion 132 extending from the first hole portion. The third coupling portion 17 may be arranged to be disposed in the first hole portion 131 through the second hole portion 132.

The bracket 100 may include the chamfer portion 133 defining the second hole portion and configured to guide the third coupling portion entering the second hole portion to the first hole portion.

The third coupling portion 17 may include the first rib portion 173 extending upwardly from the bottom of the case. The third coupling portion 17 may include the second rib portion 174 bent from the first rib portion 173 and extending toward the partition 120 while the bracket is coupled to the case.

The second coupling portion 16 may include the first extension portion 163 inclined from the bottom of the case. The second coupling portion 16 may include the second extension portion 164 inclined from the first extension portion 163. The first extension portion 163 may be configured to form the obtuse angle a relative to the bottom 11 of the case. The second extension portion 164 may be configured to form the acute angle b relative to the bottom 11 of the case.

The second coupling portion 16 may include the first extension portion 165 extending upwardly from the bottom 11 of the case. The second coupling portion 16 may include the second extension portion 166 curved from the first extension portion 165 and configured to be in contact with the partition 120 while the bracket is coupled to the case.

The first circuit board 80 may include the filter coil 81. The second circuit board 90 may include the wire 91 configured to be connected to the induction heating coil 30.

The cooking apparatus 1 according to an embodiment of the present disclosure may include: the case 10; the induction heating coil 30 disposed inside the case; the first circuit board 80 disposed inside the case and including the filter coil 81; the second circuit board 90 disposed inside the case to be spaced apart from the first circuit board 80 along the first direction D1 and including the wire 91 configured to be connected to the induction heating coil 30; the partition 120 configured to extend along the second direction D2 intersecting the first direction between the first and second circuit boards 80 and 90; and the base 110 protruding from the partition 120 in the first direction D1 and including the insertion hole 130. The case 10 may include the coupling portion 17 formed on the bottom 11 of the case and insertable into the insertion hole 130. The coupling portion 17 may include the first rib portion 171 or 173 disposed within the insertion hole 130 and configured to restrict movement of the base along the second direction D2. The coupling portion 17 may include the second rib portion 172 or 174 extending from the first rib portion 171 or 173 and disposed above the base 110 to restrict the movement of the base along a vertical direction.

The length L2 of the second rib portion 172 along the second direction D2 may be greater than the length L1 of the first rib portion 171 along the second direction D2. The height H2 of the first rib portion 171 in the vertical direction may be equal to or greater than the thickness t of the base 110.

The coupling portion may be the first coupling portion 17. The case 10 may further include the second coupling portion 15 formed on the bottom 11 of the case and configured to cover the corner 112 of the base to restrict the movement of the base along the first direction D1, the second direction D2, and the vertical direction Z.

The case 10 may further include the third coupling portion 16 extending upwardly from the bottom 11 of the case and configured to be in contact with the partition 120 to restrict the movement of the partition 120 along the first direction D1.

The cooking apparatus 1 may further include the bracket 100 configured to prevent and/or reduce electromagnetic interference between the filter coil 81 and the wire 91. The bracket 100 may include the partition 120 and the base 110. After the base is coupled to the first coupling portion 17 and the second coupling portion 15, the partition 120 may be configured to be coupled to the third coupling portion 16 in response to the bracket rotating so that the base 110 is seated on the bottom 11 of the case.

According to various exemplary embodiments of the present disclosure, the bracket 100 may be detachably coupled to the case 10 without a separate tool or a separate fastening member (e.g., a screw, a rivet, etc.). The bracket 100 may be constrained in the X-axis, Y-axis, and Z-axis directions in a state of being coupled to the case 10, and the bracket 100 may not be easily detached or separated from the case 10. The assemblability and productivity of the cooking apparatus 1 may be improved.

According to various exemplary embodiments of the present disclosure, the bracket 100 may prevent and/or reduce EMI between the first and second circuit boards 80 and 90. The reliable operation of the cooking apparatus 1 may be ensured.

The effects to be obtained from the present disclosure are not limited to those mentioned above, and other effects not mentioned will be apparent to those skilled in the art to which the present disclosure belongs from the following description.

Although certain exemplary embodiments are illustrated and described above, the present disclosure is not limited to the certain embodiments, various applications may of course be performed by those skilled in the art without deviating from what is claimed in the scope of claims, and such applications should not be understood separately from the technical idea or prospects herein.

1. A cooking apparatus comprising:
a case;
a cooking plate mountable on the case;
an induction heating coil inside the case;
a first circuit board inside the case, configured to remove noise and configured to reduce noise included in a current supplied from an external power source;
a second circuit board inside the case and configured to drive the induction heating coil; and
a bracket coupleable to the case between the first circuit board and the second circuit board, configured to prevent electromagnetic interference (EMI) and configured to reduce EMI;
wherein the bracket includes:
a base configured to be arranged on a bottom of the case, and
a partition extending upward from the base, and
wherein the case includes:
a first coupling portion, formed on the bottom of the case, configured to fix a corner of the base while the bracket is coupled to the case, and
a second coupling portion, formed on the bottom of the case, configured to support the partition while the bracket is coupled to the case.

2. The cooking apparatus of claim 1, wherein:
the first circuit board and the second circuit board are arranged along a first direction,
the base protrudes from the partition in the first direction, and
the partition extends along a second direction intersecting the first direction.

3. The cooking apparatus of claim 1, wherein the first coupling portion comprises:
a first cover portion, extending upward from the bottom of the case, configured to cover edges of the corner of the base,
a second cover portion extending from the first cover portion to cover an upper surface of the corner and
an insertion groove formed by the first cover portion and the second cover portion, wherein the corner is insertable into the insertion groove.

4. The cooking apparatus of claim 1, wherein:
the partition comprises a first surface adjacent to the base, and a second surface opposite to the first surface; and
the second coupling portion is configured to contact the second surface of the partition.

5. The cooking apparatus of claim 2, wherein the case further comprises:
a third coupling portion, formed on the bottom of the case and spaced apart from the first coupling portion along the second direction, to fix the base.

6. The cooking apparatus of claim 5, wherein the third coupling portion comprises:
a first rib portion extending upward from the bottom of the case, and
a second rib portion, extending upward from the first rib portion, on an upper surface of the base .

7. The cooking apparatus of claim 6, wherein a length of the second rib portion along the second direction is greater than a length of the first rib portion along the second direction.

8. The cooking apparatus of claim 6, wherein a height of the first rib portion in a vertical direction is equal to or greater than a thickness of the base.

9. The cooking apparatus of claim 5, wherein the bracket comprises an insertion hole formed in the base and configured such that the third coupling portion is insertable.

10. The cooking apparatus of claim 9, wherein:
the insertion hole comprises:
a first hole portion, and
a second hole portion extending from the first hole portion, and
the third coupling portion is arranged in the first hole portion through the second hole portion.

11. The cooking apparatus of claim 10, wherein the bracket comprises a chamfer portion defining the second hole portion, configured to guide the third coupling portion entering the second hole portion to the first hole portion.

12. The cooking apparatus of claim 5, wherein the third coupling portion comprises:
a first rib portion extending upward from the bottom of the case, and
a second rib portion bent from the first rib portion and extending toward the partition.

13. The cooking apparatus of claim 1, wherein the second coupling portion comprises:
a first extension portion inclined from the bottom of the case, and
a second extension portion inclined from the first extension portion,
wherein the first extension portion is configured to form an obtuse angle relative to the bottom of the case; and
the second extension portion is configured to form an acute angle relative to the bottom of the case.

14. The cooking apparatus of claim 1, wherein the second coupling portion comprises:
a first extension portion extending upward from the bottom of the case, and
a second extension portion, curved from the first extension portion, configured to contact the partition.

15. The cooking apparatus of claim 1, wherein:
the first circuit board comprises a filter coil, and
the second circuit board comprises a wire configured to connect to the induction heating coil.
